(19) United States
(12) Patent Application Publication
(10) Pub. No.: US 2026/0192328 A1
(43) Pub. Date: Jul. 9, 2026

(54) METHODS OF PRODUCING COATED OPTICAL SUBSTRATES

(71) Applicant: FLO OPTICS LTD., Petach Tikva (IL)

(72) Inventors: Ilan HIDANA, Katzir (IL); Tamir CHARTARIFSKY, Hod-Hasharon (IL); Claudio ROTTMAN SAVION, Petach Tikva (IL)

(21) Appl. No.: 19/551,667

(22) Filed: Feb. 27, 2026

Related U.S. Application Data
(63) Continuation of application No. PCT/IB2024/000481, filed on Sep. 2, 2024.
(60) Provisional application No. 63/580,003, filed on Sep. 1, 2023.
(60) Provisional application No. 63/541,279, filed on Sep. 28, 2023.
(60) Provisional application No. 63/541,292, filed on Sep. 28, 2023.
(60) Provisional application No. 63/541,293, filed on Sep. 28, 2023.

(30) Foreign Application Priority Data
Jul. 8, 2024 (GB) 2409920.2
Jul. 9, 2024 (GB) 2409979.8

(51) Int. Cl. B05D 1/30; G02B 1/14

(52) U.S. Cl. CPC B05D 1/30; G02B 1/14

(57) ABSTRACT

Methods and systems for producing an optical construction on a polymeric optical substrate that is typically curved, one such method including: (a) microvalving drops of a liquid film-forming formulation onto an optical surface of the optical substrate, to form a wet layer; and (b) treating the wet layer to produce a dried transparent layer on the optical surface.

### CROSS-REFERENCE TO OTHER PUBLICATIONS

This application is a continuation of PCT/IB2024/000481, filed on Sep. 2, 2024, which is incorporated by reference herein in its entirety. PCT/IB2024/000481 claims priority from U.S. patent application Nos. 63/580,003, filed on Sep. 1, 2023; 63/541,293, filed on Sep. 28, 2023; 63/541,279, filed on Sep. 28, 2023; 63/541,292, filed on Sep. 28, 2023; as well as from GB application nos. 2409920.2, filed on Jul. 8, 2024, and GB2409979.8, filed on Jul. 9, 2024; the teachings of all of which are incorporated herein by reference.

### FIELD AND BACKGROUND OF THE INVENTION

The present invention relates to coated optical and ophthalmic devices and articles, such as a coated lens, and to methods and apparatus for applying and forming coatings on such devices and articles.

Thermal curable coatings for lenses are often siloxane based. They may be made from various siloxane monomers, typically tetraalkoxysilanes and alkyltrialkoxysilanes that are pre-reacted with water to various extents of hydrolysis. Various organofunctional moieties may be attached to the alkyl group that is bonded directly to the central silicon atom. Typically, thermally cured coatings have appreciably higher abrasion resistance than radiation curable coatings. Thermal curable coating technologies are disclosed in various patents, including the following U.S. Pat. Nos. 4,547,397, 5,385,955, and 6,538,092. Radiation curable coatings are disclosed in U.S. Pat. Nos. 4,478,876 and 5,409,965.

Various commercial methods of producing eyeglass coatings may utilize such thermal curable coatings. In various known processes, optical impediments may be appreciably exacerbated when the target surface is a curved optical surface such as an eyeglass lens, particularly, for eyeglass lenses having high SAG numbers.

The present inventors have recognized a need for improved optical and ophthalmic devices and articles having hardcoats, and for systems and methods of producing such devices and articles, particularly at high throughputs.

### SUMMARY OF THE INVENTION

According to some teachings of the present invention there is provided a method of producing a dried transparent layer or coating on an ophthalmic substrate, the method including: (a) microvalving drops of a liquid film-forming formulation onto an ophthalmic surface of the substrate, to form a wet layer; and (b) treating the wet layer to produce a dried transparent layer on the ophthalmic surface; wherein the ophthalmic surface is a polymeric surface.

According to further teachings of the present invention there is provided a method of producing an optical or ophthalmic construction on an optical or ophthalmic substrate, the method including: (a) microvalving drops of a liquid film-forming formulation onto an optical or ophthalmic surface of the substrate, to form a wet layer; and (b) treating the wet layer to produce a dried transparent layer on said optical or ophthalmic surface, and wherein said liquid film-forming formulation is a hardcoat formulation.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 provides a schematic block diagram of a method of treating an optical surface, according to aspects of the present invention;

FIG. 2 provides a schematic block diagram of a method of treating an optical surface to produce a dried hardcoat layer, according to aspects of the present invention;

FIG. 2A provides optional steps for the schematic block diagram of FIG. 2, in which the pre-treatment may include the applying of a liquid primer formulation to the exposed surface of the ophthalmic substrate, along with subsequent drying;

FIG. 3 provides a schematic, general block diagram of a method of treating an optical surface to produce an optical construction, according to aspects of the present invention;

FIG. 4 is a schematic cross-sectional view of a multi-layered ophthalmic structure, which includes an ophthalmic substrate having an ophthalmic construction fixedly attached to a broad surface of the substrate;

FIGS. 4A and 4B are schematic representations of a microvalve apparatus jetting ink drops onto a convex lens surface and onto a concave lens surface, respectively;

FIG. 5 shows a conceptual representation of a process for coating and finishing an optical or ophthalmic substrate using a coating system, according to embodiments of the present invention;

FIGS. 6A, 6B and 6C show respective block diagrams of exemplary coating systems according to embodiments of the present invention;

FIGS. 7A and 7B show respective conceptual representations of a process for coating an optical or ophthalmic substrate using a coating system in conjunction with a surface treatment apparatus, according to embodiments of the present invention;

FIG. 8 shows a block diagram of an exemplary coating system according to embodiments of the present invention;

FIG. 9 shows a block diagram of an exemplary surface treatment apparatus according to embodiments of the present invention;

FIGS. 10A, 10B, 10C and 11 show respective conceptual representations of processes for coating and drying an optical or ophthalmic substrate, according to embodiments of the present invention;

FIGS. 12A, 12B, 12C and 12D show respective schematic views of exemplary optical substrates according to embodiments of the present invention;

FIGS. 13A and 13B show respective side and perspective schematic views of a virtual two-dimensional projection of a curved surface of an optical substrate according to embodiments of the present invention;

FIG. 14 shows a schematic side view of drop deposition on a curved surface of an optical substrate in accordance with a virtual two-dimension projection of the surface, according to embodiments of the present invention;

FIG. 15 shows a schematic top view of an optical substrate including a virtual annulus comprising an edge portion according to embodiments of the present invention; and

FIG. 16 shows a schematic side view of an optical substrate having a curved surface, showing certain aspects of the surface geometry according to embodiments of the present invention.

### DESCRIPTION OF THE PREFERRED EMBODIMENTS

The principles and operation of the optical constructions according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The inventors have found that applying one or more optical coatings to an optical substrate involves a variety of technological hurdles. Some of these relate to optical substrates, which tend to be highly smooth, and substantially non-absorbent. Optical substrates are generally transparent, and may require a high degree of transparency from the plurality of optical coatings. Moreover, the refractive index of each coating, or of all the coatings together, may be constrained to be similar to that of the optical substrate.

The optical construction or article produced must satisfy mechanical criteria such as hardness and/or scratch resistance. Each of the coatings must also be relatively inert to the other coatings in contact therewith. Moreover, since the coatings may be applied successively, at least one of the applied wet, or uncured, formulations may contact, and interact with, a previously applied coating.

The curing time of each coating or layer should be reasonable (at most minutes or hours), and the curing temperature should be sufficiently low so as not to damage the optical substrate, nor to damage any previously applied coatings.

The adhesion to the optical or ophthalmic substrate and resistance to peeling or cracking of the coating or coatings may also be crucial to obtaining a viable coated lens such as a coated ophthalmic lens. The inventors have found that such adhesion problems may markedly worsen when the hardcoat formulation contains one or more tint dyes. Without wishing to be limited by theory, the inventors believe that the presence of the tint dye at the interface of layers within an optical stack, or at the interface between the bottommost layer and the optical substrate, may appreciably compromise the bonding or attachment at such interfaces. Moreover, the inventors believe that tint dyes may exhibit an affinity for the interfacial zones, such that the concentration of a tint dye at the interface may be significant higher than the average concentration of the tint dye in the ink solids.

In addition, and with particular reference to solvent attack, the penetration of solvent from a subsequently applied layer may compromise the adhesion at the interface between these layers, and at the interface between the two previously applied layers, or between the previously applied layer and the substrate. Thus, full curing of the wet layer may be cardinal in producing an optical stack or construction having both suitable optical and mechanical properties.

Significantly, the inventors have found that solvent systems containing both high and low evaporation rate solvents may appreciably mitigate the extent of solvent penetration, when such penetration cannot be completely avoided.

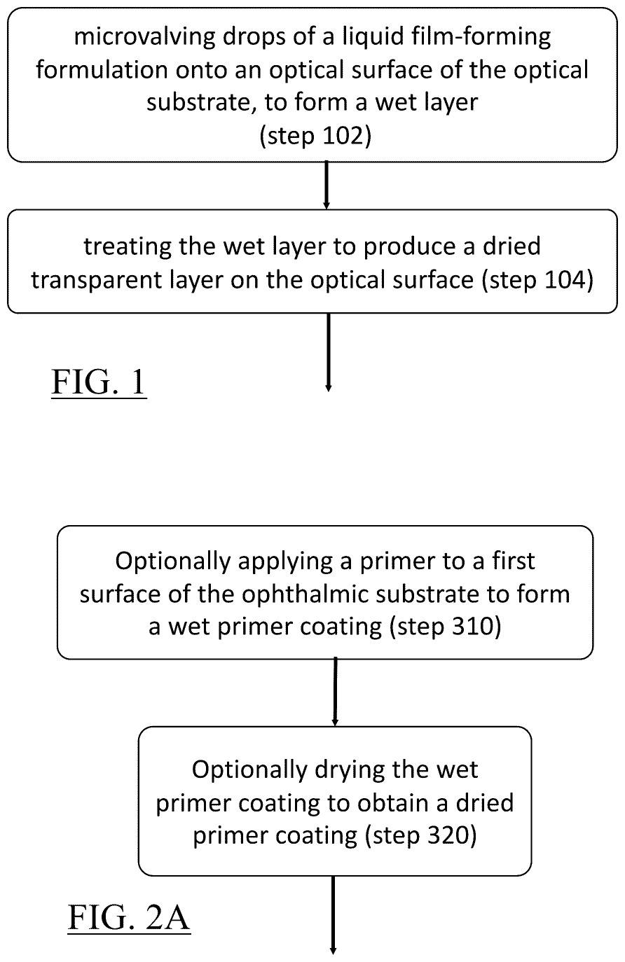

As schematically presented in FIG. 1, the method includes microvalving drops of a liquid film-forming formulation, typically a hardcoat formulation, onto an optical or ophthalmic surface of an optical or ophthalmic substrate, to form a wet layer (step 102). The microvalved drops may form a continuous and even layer on the curved or highly curved optical substrate.

The continuous, even layer may advantageously be formed under conditions of controlled flow. In uncontrolled flow, the drops slip along the surface, deviating from the digital positioning provided by the microvalve, resulting, inter alia, in uneven films, bald spots, and more. Uncontrolled flow may be appreciably more acute for low-viscosity formulations. While hardcoat formulations may be devoid of solid binders, and typically have low or very low viscosities, fixation may be achieved nonetheless by introducing high concentrations of fast-evaporating solvent into the formulation.

The inventors have found, however, that this approach may be problematic when attempting to utilize microvalving. Large microvalved drops have a high volume with respect to surface area and contact area, and tend to slip uncontrollably, the tendency compounded by their low viscosity. Fast-evaporation solvent is less effective than for small drops, partly due to the high volume to surface area. The inventors have discovered that by balancing between low and high evaporation rate solvents in the formulation, thin, continuous, even hardcoat layers may be formed, within a narrow range of drop diameters. The calculation of the drop diameter is discussed hereinbelow. This approach has been found to work for lenses within a particular range of curvature.

The term “ophthalmic substrate”, as used herein, refers to a substrate that is used by the human eye to view therethrough. The ophthalmic substrate is a component of an ophthalmic device or system, or an ophthalmic component of such a device or system. Typically, the ophthalmic substrate is a lens, and the ophthalmic surface is a surface of the lens.

More generally, the term “ophthalmic”, as used herein to modify a structure, such as “substrate”, “surface”, “construction”, “structure”, “device”, “arrangement”, and “system”, refers to the property of that structure that enables the human eye to view an object therethrough. While a coated lens is a typical example of an ophthalmic device, other applications will be appreciated by those of skill in the art, including, by way of example, a helmet having a transparent visor.

An ophthalmic construction may consist of, or include, an ophthalmic component of such an ophthalmic device or system.

The method may further comprise treating the wet layer to produce a dried/cured transparent layer on the optical surface (step 104).

For hardcoat formulations, the drying/curing is a chemical curing, in that polymerization and/or cross-linking is effected.

In some embodiments, the chemical drying/curing is or includes curing by actinic radiation, i.e., by electromagnetic radiation (e.g., UV radiation, electron beam, IR, and microwave) that is capable of initiating a chemical reaction.

The drying/curing of the wet layer may advantageously be performed so as to achieve a “fully cured” layer or coating. The inventors have found that partially cured layers may result in solvent attack, migration, mixing, etc. from an adjacent or subsequently-applied layer in the stack. These phenomena may appreciably detract from optical quality.

As used herein in the specification and in the claims section that follows, the terms “fully curing” and “fully cured” (e.g., of a formulation or layer) refers to at least 85% curing of the polymeric material, as determined by a König hardness test according to ASTM D4366 Standard Test Methods for Hardness of Organic Coatings by Pendulum Damping Tests. Thus, for a reference polymer sheet that is 100% completely cured, having a König hardness of 80, the identical material that is “fully-cured” or has undergone “full curing” would have a König hardness within a range of 68 (0.85·80) to 80. Thus, the “fully cured” polymeric material has a minimum hardness coefficient (C_{H}) of at least 0.85.

Typically, the optical surface is a curved optical surface, such as a polymeric lens surface.

Typically, the optical surface is a polymeric surface, such as a polymeric lens surface.

The dried transparent layer has a hardness that may be characterized by pencil hardness. In the specification and claims, all pencil hardness values are measured according to ASTM D3363.

In some embodiments, the dried transparent layer has a pencil hardness of at least H.

In some embodiments, the dried transparent layer has a pencil hardness of at least 2H.

In more typical embodiments, the pencil hardness of the dried transparent layer is within a range of H to 10H, 2H to 10H, 2H to 9H, 2H to 8H, 2H to 7H, 3H to 10H, 3H to 9H, 3H to 8H, 3H to 7H, 4H to 10H, 4H to 9H, 4H to 8H, 4H to 7H, 5H to 10H, 5H to 9H, or 5H to 8H.

For dry or completely cured hardcoat layers, the pencil hardness of the dried or completely cured layer is usually at least 3H, and more typically, at least 4H or at least 5H.

As used herein in the specification and in the claims section that follows, the term “standard pencil hardness unit” and the like refers to one degree of hardness on the 19-degree scale of graphite pencil hardness: 14B, 12B, 10B, 8B, 7B, 6B, 5B, 4B, 3B, 2B, B, HB, F, H, 2H, 3H, 4H, 5H, and 6H. By way of example: a 3H degree of hardness exceeds a 2H degree of hardness by 1 standard pencil hardness unit; a 2H degree of hardness exceeds an F degree of hardness by 2 standard pencil hardness units.

In some embodiments, the ophthalmic substrate or lens may be coated or pre-coated with a hardcoat, and the microvalving of liquid film-forming drops may be performed on or directly on top of this “precoated” hardcoat (i.e., the hardcoat that comes with/is integral to the lens blank).

In some embodiments, a primer may first be applied to this precoated hardcoat, prior to the application of any additional layer, in order to enhance adhesion of the additional layer to the substrate.

The jetting of the liquid hardcoat formulation onto the optical/ophthalmic substrate may be performed by a digital microvalving technology, according to a pre-determined pattern such as a pre-determined digital pattern.

In some embodiments, the microvalving of the liquid film-forming formulation is performed by a microvalve in a microvalve system.

In some embodiments, the microvalve is piezo-actuated (e.g., using a Nordson Pulse Jet Valve, a Vermes MDS 1560 Series, or a Techcon 9800 series);

In some embodiments, the microvalve is electromagnetically actuated (e.g., using a solenoid valve). The fluid or dispersion flows through the microvalve directly. When a current is applied through the valve coil, a mobile anchor attached to a valve ball is magnetically pulled by the magnetic field of a stationary anchor. The microvalve opens, discharging a portion of the medium. When no current is applied, the microvalve is closed, as a closing spring acts on the mobile anchor associated with the valve ball.

Exemplary microvalves of this type are manufactured by Fritz Gyger AG and by the Lee company.

In some embodiments, the microvalve is electro-pneumatically actuated. Exemplary microvalves of the this type are the Liquidyn® P-Jet Series, manufactured by Nordson.

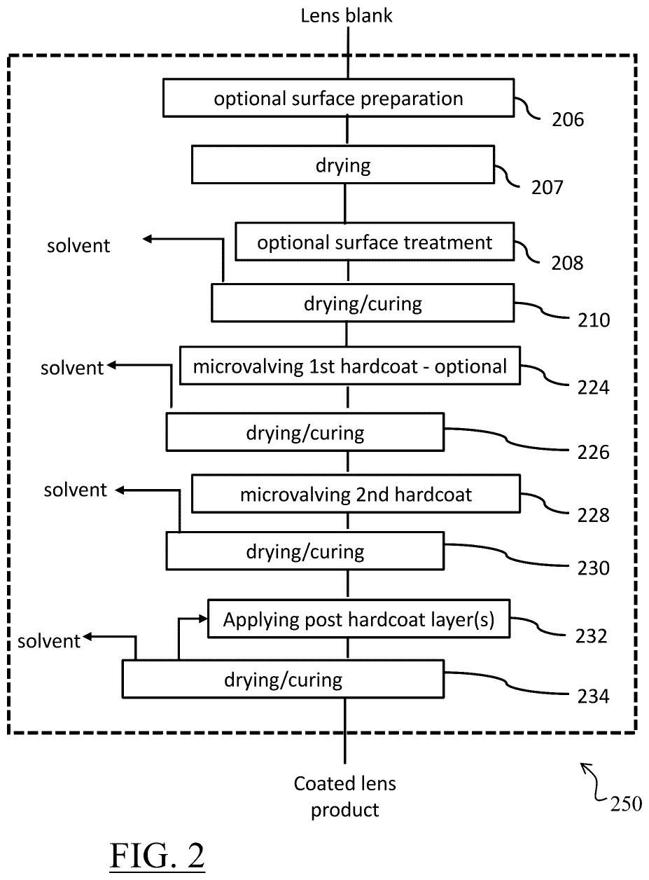

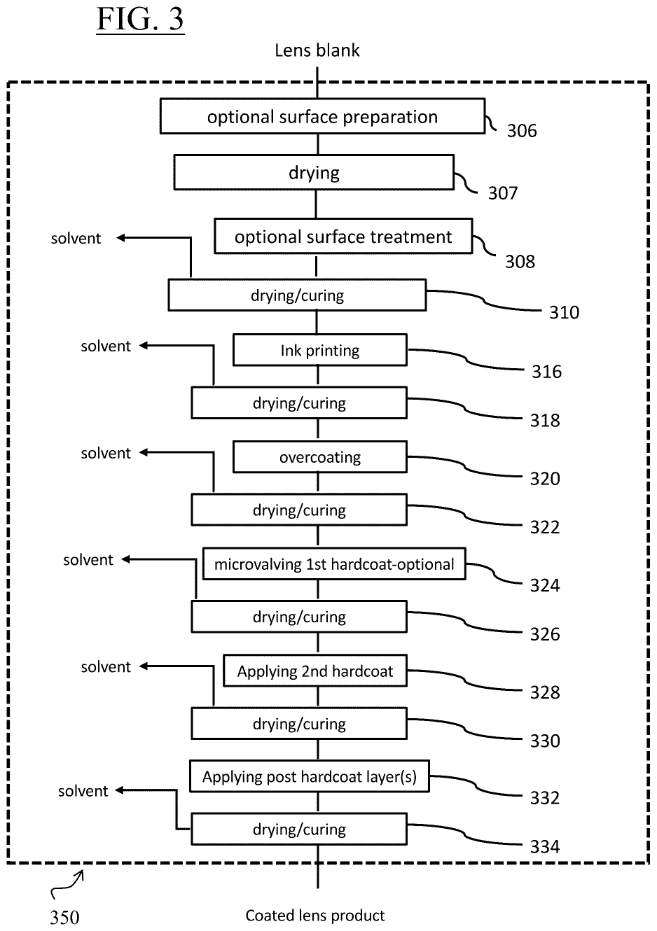

With reference now to FIGS. 2 and 3, FIG. 2 provides a schematic block diagram of a process of treating an optical surface of an optical substrate (typically, a lens blank) to produce a dried hardcoat layer, according to aspects of the present invention. The lens blank provided to the process may or may not have a protective hardcoat adhering thereto. FIG. 3 provides a schematic, general block diagram of a method of treating an optical surface to produce an optical construction, according to aspects of the present invention.

The lens blank/optical substrate may be subjected to surface preparation (step 206) prior to application of the first hardcoat layer. Such surface preparation may include washing in water or in an aqueous cleaning solution, optionally followed by drying (step 207).

In some embodiments, the surface preparation of the lens surface includes an etching treatment.

In some embodiments, the etching treatment includes laser etching.

In some embodiments, the etching treatment includes chemical etching.

Before applying a hardcoat formulation, the lens blank may be subjected to surface treatment (step 208), e.g., an energy treatment to raise the surface energy of the optical surface.

In some embodiments, the pre-treatment of the lens surface includes a corona treatment.

In some embodiments, the pre-treatment of the lens surface includes a plasma treatment.

In some embodiments, the pre-treatment of the lens surface includes an electron beam treatment.

In some embodiments, the pre-treatment of the lens surface includes an electrical discharge treatment.

Following any of steps 206, 207, 208, 310, 320, and 322, as well as combinations thereof, the method may optionally include, following curing (step 210, 310, 318, 322), microvalving drops of a liquid film-forming hardcoat (“1^{st} hardcoat” or “inner hardcoat”) formulation onto an optical or ophthalmic surface of an optical or ophthalmic substrate, to form a wet layer (step 224). This may be followed by treating the wet layer to produce a dried/cured transparent hardcoat layer on the optical surface (step 226). These steps have been described hereinabove with respect to steps 102 and 104.

In the embodiments provided in FIG. 2, after any of steps 206, 207, 208, 310, 320, 322, 224, and 226, as well as combinations thereof, the method includes, following curing (any of steps 210, 310, 318, 322, 326), microvalving drops of a liquid film-forming hardcoat (“2^{nd} hardcoat” or “outer hardcoat”) formulation onto an optical or ophthalmic surface of an optical or ophthalmic substrate, to form a wet layer (step 228). This may be followed by treating the wet layer to produce a dried transparent hardcoat layer on the optical surface (step 230). These steps have been described hereinabove with respect to steps 102 and 104.

In some embodiments, the hardcoat formulation base includes one or more acrylates, methacrylates, and the like, some of which are provided below in non-exhaustive fashion:
hydroxyethyl acrylate, hydroxypropyl acrylate, hydroxybutyl acrylate, hydroxy-poly(alkyleneoxy)alkyl acrylate, caprolactone acrylate, ethylene glycol diacrylate, butanediol diacrylate, hexanediol diacrylate, hexamethylene diacrylate, diethylene glycol diacrylate, triethylene glycol diacrylate, tetraethylene glycol diacrylate, polyethylene glycol diacrylate, dipropylene glycol diacrylate, tripropylene glycol diacrylate, tetrapropylene glycol diacrylate, polypropylene glycol diacrylate, glyceryl ethoxylate diacrylate, glyceryl propoxylate diacrylate, trimethylolpropane triacrylate, trimethylolpropane ethoxylate triacrylate, trimethylolpropane propoxylate triacrylate, neopentyl glycol diacrylate, neopentyl glycol ethoxylate diacrylate, neopentyl glycol propoxylate diacrylate, monomethoxy trimethylolpropane ethoxylate diacrylate, pentaerythritol ethoxylate tetraacrylate, pentaerythritol propoxylate tetraacrylate, dipentaerythritol pentaacrylate, dipentaerythritol ethoxylate pentaacrylate, dipentaerythritol propoxylate pentaacrylate, di-trimethylolpropane ethoxylate tetraacrylate, bisphenol A ethoxylate diacrylate containing from 2 to 30 ethoxy groups, bisphenol A propoxylate diacrylate containing from 2 to 30 propoxy groups, bisphenol A alkoxylated diacrylate containing a mixture of from 2 to 30 ethoxy and propoxy groups, bisphenol A glycerolate dimethacrylate, bisphenol A glycerolate (1 glycerol/1 phenol) dimethacrylate, glycidyl acrylate, β-methylglycidyl acrylate, bisphenol A-monoglycidyl ether acrylate, 4-glycidyloxybutyl methacrylate, 3-(glycidyl-2-oxyethoxy)-2-hydroxypropyl methacrylate, 3-(glycidyloxy-1-isopropyl oxy)-2-hydroxypropyl acrylate, 3-(glycidyloxy-2-hydroxypropyloxy)-2-hydroxy propyl acrylate, and 3-(trimethoxysilyl) propyl methacrylate.

UV catalysts for the photo-polymerization initiation may include, by way of example, any of the following materials: benzil, benzoin, benzoin methyl ether, benzoin isobutyl ether, benzophenol, acetophenone, benzophenone, 4,4′-dichlorobenzophenone, 4,4′-bis(N,N′-dimethylamino)benzophenone, diethoxyacetophenone, fluorones, e.g., the H-Nu series of initiators available from Spectra Group Limited, 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, such as 2,6-dimethylbenzoyl diphenyl phosphine oxide, 2,4,6-trimethylbenzoyl diphenyl phosphine oxide, 2,6-dichlorobenzoyl diphenyl phosphine oxide, and 2,6-dimethoxybenzoyl diphenyl phosphine oxide; bisacylphosphine oxides, such as bis(2,6-dimethyoxybenzoyl)-2,4,4-trimethylpentyl phosphine oxide, bis(2,6-dimethylbenzoyl)-2,4,4-trimethylpentyl phosphine oxide, bis(2,4,6-trimethylbenzoyl)-2,4,4-trimethylpentyl phosphine oxide, and bis(2,6-dichlorobenzoyl)-2,4,4-trimethylpentyl phosphine oxide; phenyl-4-octyloxyphenyliodonium hexafluoroantimonate, dodecyldiphenyliodonium hexafluoroantimonate, (4-(2-tetradecanol)oxyphenyl)-iodonium hexafluoroantimonate, as well as mixtures thereof.

In some embodiments, the ophthalmic hardcoat formulation is based upon Sol-gel monomers and oligomers. While the chemistry is well known to those of skill in the art, a background is provided hereinbelow:

### Silane Monomers

The silanes may include hydrolyzable organoalkoxysilanes of the general formula

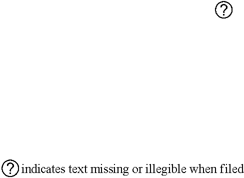

wherein R is an organic radical, R′ is preferably a low molecular weight alkyl radical, and X is preferably at least 1 and less than 4.

R is preferably a low molecular weight moiety selected from the group consisting of alkyl, vinyl, methoxyethyl, phenyl, γ-glycidoxypropyl or γ-methacryloxypropyl, and preferably having 1-6 carbon atoms. R′ is preferably a two to four carbon alkyl group. Particularly preferred organoalkoxysilanes are those wherein R is methyl and R is ethyl, such as methyl triethoxysilane.

The Sol may be elaborated from at least one alkoxysilane such as an epoxysilane, preferably tri-functional, and/or a hydrolyzate thereof, obtained for example by hydrolysis with a hydrochloric acid solution. After the hydrolysis step, the duration of which is generally about 2 to 24 hours, and typically between 2 and 6 hours, one or more catalysts may be added. A surfactant compound may be added to promote the optical quality of the deposition.

The preferred epoxyalkoxysilanes comprise an epoxy grouping and three alkoxy groupings, the latter being linked directly to the silicon atom. A preferred epoxyalkoxysilane may be an alkoxysilane carrying a β-(3,4-epoxycyclohexyl) grouping, such as β-(3,4-epoxycyclohexyl)ethyl-trimethoxysilane.

The preferred epoxyalkoxysilanes may be represented by the following formula:

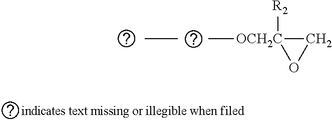

wherein: R¹ is an alkyl grouping of 1 to 6 carbon atoms, preferably a methyl or ethyl grouping, R² is a methyl grouping or a hydrogen atom, a is an integer from 1 to 6, and b represents 0, 1 or 2.

Examples of such epoxysilanes include γ-glycidoxypropyl-triethoxysilane or γ-glycidoxypropyl-trimethoxysilane γ-glycidoxypropylmethyl-dimethoxysilane, γ-glycidoxypropyl-methyldiethoxysilane and γ-glycidoxyethoxypropyl-methyldimethoxysilane. The epoxydialkoxysilanes are preferably used in smaller ratios than the epoxytrialkoxysilanes.

Other preferred alkoxysilanes may be represented by the following formula:

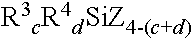

wherein R³ and R⁴ are selected among the alkyl, methacryloxyalkyl, alkenyl and aryl groups, substituted or not (examples of substituted alkyl groupings are the halogenated alkyls, notably chlorinated or fluorinated); Z is a alkoxy, alkoxyalkoxy or alkyloxy group; c and d equals 0, 1 or 2, respectively; and c+d equals 0, 1 or 2. This formula includes the following compounds: (1) tetraalkoxysilanes, such as methylsilicate, ethylsilicate, n-propylsilicate, isopropylsilicate, n-butylsilicate, sec-butylsilicate, and t-butylsilicate, and/or (2) trialkoxysilanes, trialkoxyalkoxylsilanes or triacyloxysilanes, such as methyltrimethoxysilane, methyltriethoxysilane, vinyltrimethoxysilane, vinyltriethoxysilane, vinyltrimethoxyethoxysilane, vinyltriaketoxysilane, phenyltrimethoxysilane, phenyltriethoxysilane, γ-chloropropyltrimethoxysilane, γ-trifluoropropyltrimethoxysilane, methacryloxypropyltrimethoxysilane, and/or (3) dialkoxysilanes, such as dimethyldimethoxysilane, γ-chloropropylmethyldimethoxysilane and methylphenyldimethoxysilane.

In some embodiments, the coating compositions utilized in conjunction with the present invention comprise an aqueous organic solvent mixture containing from about 10 to about 99.9 weight percent, based on the total solids of the composition, of a mixture of hydrolysis products and partial condensates of an epoxy functional silane and a tetrafunctional silane and from about 0.1 to about 30 weight percent, based on the total solids of the composition, of a crosslinking crosslinking multifunctional compound selected from the group consisting of crosslinking multifunctional carboxylic acids, crosslinking multifunctional anhydrides and combinations thereof.

The epoxy functional silane and the tetrafunctional silane may be present in the aqueous-organic solvent mixture in a molar ratio of from about 0.1:1 to about 5:1. The coating compositions of the present invention may further include from about 0.1 to about 50 weight percent of a mixture of hydrolysis products and partial condensates of one or more silane additives, based on the total solids of the composition, and/or an amount of colloidal silica or a metal oxide or combinations thereof equivalent to from about 0.1 to about 50 weight percent solids, based on the total solids of the composition.

Those of skill in the art will appreciate that: (a) the descriptions herein of coating formulations that contain epoxy functional silanes, tetrafunctional silanes, silane additives which do not contain an epoxy functional group, and the crosslinking multifunctional component refer to the incipient silanes and crosslinking multifunctional components from which the coating system is formed; (b) when the epoxy functional silanes, tetrafunctional silanes, and silane additives which do not contain an epoxy functional group, are combined with the aqueous solvent mixture, partial or fully hydrolyzed species will result; (c) the resultant fully or partially hydrolyzed species will combine to form mixtures of crosslinking multifunctional oligomeric siloxane species; (d) these oligomers may or may not contain both pendant hydroxy and pendant alkoxy moieties and will be comprised of a silicon-oxygen matrix which contains both silicon-oxygen siloxane linkages and silicon-oxygen crosslinking multifunctional component linkages; and (e) the oligomeric suspensions are dynamic and may undergo structural changes that depend on various factors, including: temperature, pH, water content, and catalyst concentration.

Generally, however, desirable results can be obtained where the epoxy functional silane and the tetrafunctional silane are present in the aqueous-solvent mixture in a molar ratio of from about 0.1:1 to about 5:1, or from about 0.1:1 to about 3:1.

### Formulation Components

Water: While the presence of water in the aqueous-organic solvent mixture is necessary to form hydrolysis products of the silane components of the mixture, the actual amount can vary widely. Essentially enough water is needed to provide a substantially homogeneous coating mixture of hydrolysis products and partial condensates of the epoxy functional silane and the tetrafunctional silane which, when applied and cured on an article, provides a substantially transparent coating with a Bayer number of at least 5 or at least 6 when using ASTM F735-21. It will be recognized by those skilled in the art that this amount of water can be determined empirically.

Solvent: The solvent constituent of the aqueous-organic solvent mixture of the coating compositions of the present invention can be any solvent or combination of solvents which is compatible with the epoxy functional silane, the tetrafunctional silane and the crosslinking multifunctional component. For example, the solvent constituent of the aqueous-organic solvent mixture may be alcohol, ether, glycol or glycol ether, ketone, ester, glycolether acetate and mixtures thereof.

Families of alcohols: Suitable alcohols can be represented by the formula ROH, where R is an alkyl group containing from 1 to about 10 carbon atoms. Specific examples of useful alcohols include at least one of: methanol, ethanol, propanol, isopropanol, butanol, isobutanol, secondary butanol, tertiary butanol, cyclohexanol, pentanol, octanol and decanol.

Families of glycols: Suitable glycols, ethers, glycol ethers can be represented by the formula R¹—(OR²)ₓ—OR¹ where x is 0, 1, 2, 3 or 4, R¹ is hydrogen or an alkyl group containing from 1 to about 10 carbon atoms and R² is an alkylene group containing from 1 to about 10 carbon atoms and combinations thereof. Examples of glycols, ethers and glycol ethers having the above-defined formula, and which may be used as the solvent constituent of the aqueous-organic solvent mixture of the instant coating compositions, include at least one of: di-n-butylether, ethylene glycol dimethyl ether, propylene glycol dimethyl ether, propylene glycol methyl ether, dipropylene glycol methyl ether, tripropylene glycol methyl ether, dipropylene glycol dimethyl ether, tripropylene glycol dimethyl ether, ethylene glycol butyl ether, diethylene glycol butyl ether, ethylene glycol dibutyl ether, ethylene glycol methyl ether, diethylene glycol ethyl ether, diethylene glycol dimethyl ether, ethylene glycol ethyl ether, ethylene glycol diethyl ether, ethylene glycol, diethylene glycol, triethylene glycol, propylene glycol, dipropylene glycol, tripropylene glycol, butylene glycol, dibutylene glycol, and tributylene glycol.

Families of cyclic ethers: cyclic ethers such as tetrahydrofuran and dioxane may be suitable ethers for the aqueous-organic solvent mixture.

Families of Ketones: Examples of ketones suitable for the aqueous-organic solvent mixture include at least one of: acetone, diacetone alcohol, methyl ethyl ketone, cyclohexanone, and methyl isobutyl ketone.

Families of esters: Examples of esters suitable for the aqueous-organic solvent mixture include at least one of: ethyl acetate, n-propyl acetate, and n-butyl acetate.

Families of glycol ether acetates: Examples of glycol ether acetates suitable for the aqueous organic solvent mixture include at least one of: propylene glycol methyl ether acetate, dipropylene glycol methyl ether acetate, ethyl 3-ethoxypropionate, and ethylene glycol ethyl ether acetate.

### 1. Silanes

### Epoxy Functional Silane:

Representative Structure of epoxy silanes: such epoxy functional silanes are typically represented by the formula R³ₓSi(OR⁴)₄₋ₓ where X is typically an integer of 1, 2 or 3, R³ is H, an alkyl group, a functionalized alkyl group, an alkylene group, an aryl group, an alkyl ether, and combinations thereof containing from 1 to about 10 carbon atoms and having at least 1 epoxy functional group, and R⁴ is H, an alkyl group containing from 1 to about 5 carbon atoms, an acetyl group, an —Si(OR⁵)_{3-y}R⁶_{y} group where y is an integer of 0, 1, 2, or 3, and combinations thereof, where R⁵ is H, an alkyl group containing from 1 to about 5 carbon atoms, an acetyl group, or another Si(OR⁵)_{3-y}R⁶_{y} group and combinations thereof, and R⁶ is H, an alkyl group, a functionalized alkyl group, an alkylene group, an aryl group, an alkyl ether, and combinations thereof containing from 1 to about 10 carbon atoms which may also contain an epoxy functional group.

Examples of epoxy functional silanes (supplier Gelest or Merck): glycidoxypropyltrimethoxysilane, 3-glycidoxypropyltrihydroysilane, 3-glycidoxypropyldimethylhydroxysilane, 3-glycidoxypropyltrimethoxysilane, 3-glycidoxypropyltriethoxysilane, 3-glycidoxypropyldimethoxymethylsilane, 3-3-glycidoxypropyltributoxysilane, 1,3-glycidoxypropyldimethoxymethoxylsilane, bis(glycidoxypropyl)tetramethyldisiloxane, 1,3-bis(glycidoxypropyl)tetramethoxydisiloxane, 1,3-bis(glycidoxypropyl)-1,3-dimethyl-1,3-dimethoxydisiloxane, 2,3-epoxypropyltrimethoxysilane, 3,4-epoxybutyltrimethoxysilane, 6,7-epoxyheptyltrimethoxysilane, 9,10 epoxydecyltrimethoxysilane, 1,3-bis(2,3-epoxypropyl)tetramethoxydisiloxane, 1,3-bis(6,7-epoxyheptyl)tetramethoxy disiloxane, 2-(3,4-epoxycyclohexyl)ethyltrimethoxysilane.

### Tetrafunctional Silanes:

Representative Structure of tetrafunctional silanes: tetrafunctional silanes may be represented by the formula Si(OR⁷)₄, where R⁷ is H, an alkyl group containing from 1 to about 5 carbon atoms and ethers thereof, an (OR⁷) carboxylate a —Si(OR⁸) group where R is a H, an alkyl group containing from 1 to about 5 carbon atoms and ethers thereof, an OR³ carboxylate or another —Si(OR⁸)₃ group and combinations thereof.

Examples of tetrafunctional silanes represented by Si(OR⁷) (supplier Gelest or Merck): at least one of: tetramethyl orthosilicate, tetraethyl orthosilicate, tetra n-propyl orthosilicate, tetraisopropyl orthosilicate, tetrabutyl orthosilicate, tetraisobutyl orthosilicate, tetrakis(methoxyethoxy)silane, tetrakis(methoxypropoxy)silane, tetrakis(ethoxyethoxy)silane, tetrakis(methoxyethoxyethoxy)silane, trimethoxyethoxysilane, dimethoxydiethoxysilane, triethoxymethoxysilane, poly(dimethoxysiloxane), poly(diethoxysiloxane), poly(dimethoxydiethoxysiloxane), tetrakis(trimethoxysiloxy)silane, tetrakis(triethoxysiloxy)silane.

Examples of tetrafunctional Silanes with carboxylate functionalities (supplier Gelest): in addition to the R⁷ and R⁸ substituents described above for the tetrafunctional silane, R⁷ and R⁸ taken with oxygen (OR⁷) and (OR⁸) can be carboxylate groups, including: silicon tetracetate, silicon tetrapropionate, silicon tetrabutyrate.

Additives (no silanes): Crosslinking multifunctional compounds: any crosslinking multifunctional carboxylic acid, crosslinking multifunctional anhydride, and combinations thereof which is compatible and capable of interacting with the hydrolysis products and partial condensates of the epoxy functional silane and the tetrafunctional silane to provide a coating composition which, upon curing, produces a substantially transparent, abrasion resistant coating having a Bayer number of at least 5. The nature of the interaction between the epoxy functional silane, the tetrafunctional silane and the crosslinking multifunctional compound, and the effect that such interaction has on the abrasion resistance of the cured coating is not fully understood. It is believed, however, that the crosslinking multifunctional compound acts as more than just a hydrolysis catalyst for the silanes. In this regard, it has been suggested that the crosslinking multifunctional compound has specific activity towards the epoxy functionality on the silane. The reaction of the epoxy groups with carboxylic acids is well known and can occur under either acidic or basic conditions. The carboxylate groups on the crosslinking multifunctional compound will also most likely have Some activity towards the silicon atoms in the matrix; and such interaction may be through normal exchange reactions with residual alkoxide and hydroxide groups or, alternatively, through some hypervalent state on the silicon atoms. The actual interaction involving the crosslinking multifunctional compound may, in fact, be a combination of all the above possibilities, the result of which would be a highly crosslinked matrix. Thus, the matrix is enhanced through extended linkages involving the crosslinking multifunctional compound. As examples of the significance of these possible interactions, coatings prepared with non-crosslinking multifunctional compounds, for example acetic acid, fail to show the same high degree of stability and abrasion resistance as obtained using the crosslinking multifunctional compounds.

Examples of crosslinking multifunctional carboxylic acids (Supplier Merck): at least one of: malic acid, aconitic acid (cis,trans), itaconic acid, succinic acid, malonic acid, glutaric acid, adipic acid, pimelic acid, suberic acid, azelaic acid, sebacic acid, cyclohexyl succinic acid, 1,3,5 benzene tricarboxylic acid, 1,2,4,5 benzene tetracarboxylic acid, 1,4-cyclohexane dicarboxylic acid, 1,3-cyclohexane dicarboxylic acid, 1,1-cyclohexanediacetic acid, 1,3-cyclohexane diacetic acid, 1,3,5-cyclohexane tricarboxylic acid, unsaturated dibasic acids such as fumaric acid and maleic acid.

Examples of crosslinking multifunctional anhydrides (supplier Merck): at least one cyclic anhydrides of the above-mentioned dibasic acids, including succinic anhydride, itaconic anhydride, glutaric anhydride, trimelitic anhydride, pyromellitic anhydride, phthalic anhydride, and maleic anhydride.

### 2. Additives of Silanes Hydrolysis and Partial Condensates Products

Silanes additives structure: The selection of the silane additive, as well as the amount of such silane additive incorporated into the coating compositions will depend upon the particular properties to be enhanced or imparted to either the coating composition or the cured coating composition. For example, when the difunctional silane dimethyldimethoxysilane is utilized as the silane additive and incorporated into the coating composition in an amount of about 10% or less, based on the total solids of the composition, the viscosity increase is greatly reduced during aging of the coating composition, without greatly affecting the resultant abrasion resistance of the cured coating. The coating compositions may further include from about 0.1 to about 50 weight percent, based on the weight of total solids of the coating compositions, of a mixture of hydrolysis products and partial condensates of one or more silane additives (i.e., trifunctional silanes, difunctional silanes, monofunctional silanes, and mixtures thereof). The silane additives which can be incorporated into the coating compositions of the present invention have the formula R⁹ₓSi(OR¹⁰)₄₋ₓ where x is a number of 1, 2 or 3; R⁹ is H, or an alkyl group containing from 1 to about 10 carbon atoms, a functionalized alkyl group, an alkylene group, an aryl group an alky ether group and combinations thereof; R¹⁰ is H, an alkyl group containing from 1 to about 10 carbon atoms, an acetyl group; and combinations thereof.

Examples of silane additives (Suppliers Gelest or Merck): methyltrimethoxysilane, ethyltrimethoxysilane, propyltrimethoxysilane, butyltrimethoxysilane, isobutyltrimethoxysilane, hexyltrimethoxysilane, octyltrimethoxysilane, decyltrimethoxy silane, cyclohexyl trimethoxy silane, cyclohexylmethyltrimethoxy silane, 3-methacryloxypropyltrimethoxy silane, vinyltrimethoxy silane, allyltrimethoxy silane, dimethyldimethoxysilane, 2-(3-cyclohexenyl)ethyltrimethoxysilane, 3-cyanopropyltrimethoxysilane, 3-chloropropyltrimethoxysilane, 2-chloroethyltrimethoxysilane, phenethyltrimethoxysilane, 3-mercaptopropyltrimethoxysilane, 3-aminopropyltrimethoxysilane, phenyltrimethoxysilane, 3-isocyanopropyltrimethoxysilane, N-(2-aminoethyl)-3-aminopropyltrimethoxysilane, 4-(2-aminoethylaminomethyl)phenethyltrimethoxysilane, chloromethyltriethoxysilane, 2-chloroethyltriethoxysilane, 3-chloropropyltriethoxysilane, phenyltriethoxysilane, ethyltriethoxysilane, propyltriethoxysilane, butyltriethoxysilane, isobutyltriethoxysilane, hexyltriethoxysilane, octyltriethoxysilane, decyltriethoxysilane, cyclohexyltriethoxysilane, cyclohexylmethyltriethoxysilane, 3-methacryloxypropyltriethoxysilane, vinyltriethoxysilane, allyltriethoxysilane, 2-(3-cyclohexenyl)ethyltriethoxysilane, 3-cyanopropyltriethoxysilane, 3-methacrylamidopropyltriethoxysilane, 3-methoxypropyltrimethoxysilane, 3-ethoxypropyltrimethoxysilane, 3-propoxypropyltrimethoxysilane, 3-methoxyethyltrimethoxysilane, 3-ethoxyethyltrimethoxysilane, 3-propoxyethyltrimethoxysilane, 2-methoxy(polyethyleneoxy)propylheptamethyltrisiloxane, methoxy(polyethylene oxy)propyltrimethoxysilane, methoxy(polyethylene oxy)ethyltrimethoxysilane, methoxy(polyethylene oxy)propyl-triethoxysilane, and methoxy(polyethyleneoxy)ethyltriethoxysilane.

### 3. Additives of Nanoparticles:

Use of nanoparticles: Colloidal silica, when added to a coating composition, is considered a reactive material. The surface of the silica is covered with silicon bound hydroxyls, some of which are deprotonated, which can interact with materials in the coating composition. The extent of these interactions is dictated by a variety of factors, including solvent system, pH, concentration, and ionic strength. It has been observed that the addition of colloidal silica to the coating compositions of the present invention can further enhance the abrasion resistance of the cured coating compositions and can further contribute to the overall stability of the coating compositions. The manufacturing process further affects these interactions. Colloidal silica can be added into a coating formulation in different ways with different results. In the coating compositions of the present invention, colloidal silica can be added into the coating compositions in a variety of different ways. In some instances, it is desirable to add the colloidal silica in the last step of the reaction sequence. In other instances, colloidal Silica is added in the first step of the reaction sequence. In yet other instances, colloidal silica can be added in an intermediate step in the sequence. The most significant results have been achieved with the use of aqueous basic colloidal silica, that is, aqueous mixtures of colloidal silica having a pH greater than 7. In such cases, the high pH is accompanied by a higher concentration of a stabilizing counterion, such as the sodium cation. Cured coatings formulated from the coating compositions which contain basic colloidal silicas have shown abrasion resistance comparable to those of a catalyzed coating composition of the present invention (that is, a composition of hydrolysis products and partial condensates of an epoxy functional silane, a tetrafunctional silane, a multi-functional compound and a catalyst such as sodium hydroxide), but the coating compositions containing colloidal silica have enhanced stability with respect to the catalyzed compositions which do not contain colloidal Silica. In the same manner, it is also possible to add other metal oxides into the coating compositions. Such additions may be made instead of, or in addition to, any colloidal silica additions. Metal oxides may be added to the coatings to provide or enhance specific properties of the cured coating, such as abrasion resistance, refractive index, anti-static, anti-reflectance, weatherability, etc. Examples of metal oxides which may be used in the coating compositions of the present invention include silica, zirconia, titania, ceria, tin oxide and mixtures thereof. When colloidal silica and/or metal oxides are added, it is desirable to add from about 0.1 to about 50 weight percent of solids of the colloidal silica and/or metal oxides, based on the total solids of the composition, to the coating compositions of the present invention. The colloidal silica and/or metal oxides will generally have a particle size in the range of 2 to 150 millimicrons in diameter, and more desirably, a particle size in the range of from about 2 to 50 millimicrons.

Examples of type of silica particles: Colloidal silica is commercially available under a number of different tradename designations, including Nalcoage) (Nalco Chemical Co., Naperville, Ill.); Nyacol® (Nyacol Products, Inc., Ashland, Md.); Snowtex® (Nissan Chemical Industries, LTD., Tokyo, Japan); Ludox® (DuPont Company, Wilmington, Del.); and Highlink OG® (Hoechst Celanese, Charlotte, N.C.). The colloidal Silica is an aqueous or organic solvent dispersion of particulate silica and the various products differ principally by particle size, silica concentration, pH, presence of stabilizing ions, solvent makeup, and the like.

### 4. Additives—Catalysts:

Use of catalysts: Although a catalyst is not an essential ingredient the addition of a catalyst can affect abrasion resistance and other properties of the coating including stability, tinting capacity, porosity, cosmetics, caustic resistance, water resistance and the like. The amount of catalyst used can vary widely, but when present will generally be in an amount sufficient to provide from about 0.1 to about 10 weight percent, based on the total solids of the composition.

Examples of catalysts: metal acetylacetonates, diamides, imidazoles, amine and ammonium salts, organic sulfonic acids and amine salts thereof, alkali metal salts of carboxylic acids, alkali metal hydroxides, fluoride salts, aluminum, zinc, iron and cobalt acetylacetonates, dicyandiamide, 2-methylimidazole, 2-ethyl-4-methylimidazole, 1-cyanoethyl-2-propylimidazole, benzyldimethylamine, 1,2-diaminocyclohexane, trifluoromethanesulfonic acid, sodium acetate, sodium and potassium hydroxide, tetra n-butylammonium fluoride.

### 5. Additives—Surfactants (Suppliers: Altana, BASF, 3M):

Use of wetting and leveling agents: An effective amount of a leveling or flow control agent can be incorporated into the composition to more evenly spread or level the composition on the surface of the substrate and to provide substantially uniform contact with the substrate. The amount of the leveling or flow control agent can vary widely, but generally is an amount sufficient to provide the coating composition with from about 10 to about 5,000 ppm of the leveling or flow control agent. Any conventional, commercially available leveling or flow control agent which is compatible with the coating composition and the substrate, and which is capable of leveling the coating composition on a Substrate and which enhances wetting between the coating composition and the Substrate can be employed.

Examples of such leveling or flow control agents: Byk and Efka surfactants also organic polyethers such as TRITON X-100, X-405, N-57 from Rohm and Haas, SILWET L-77, and SILWET L-7600 from OSi Specialties, and fluorosurfactants such as FLUO RAD FC-171, FLUORAD FC-430 and FLUORAD FC-431 from 3M Corporation.

### 6. Additives—Functional:

Functional additives may be added to enhance the usefulness of the coating compositions or the coatings produced by curing the coating compositions.

Examples of functional additives: ultraviolet absorbers, antioxidants, and the like.

Referring again to FIG. 2, when two or more layers of hardcoat are applied to the substrate, the outermost layer will typically be the hardest. The one or more inner layers of hardcoat may be somewhat softer, and may be adapted such that there is a gradual change in physical properties (e.g., hardness, coefficient of thermal expansion, etc.), to impart improved mechanical properties to the layered stack. This may be of particular importance if the stack includes one or more relatively soft photochromic layers, as will be developed in further detail hereinbelow. It must be emphasized that when a single hardcoat layer is applied, this layer is the “outer hardcoat” of step 228.

In some embodiments, the outermost hardcoat layer or coating, as a wet layer, has a thickness or an average thickness within a range of 1.5 to 40 μm or within a range of 2.5 to 40 μm, and more typically, within a range of 3 to 30 μm, 3 to 25 μm, 4 to 25 μm, 3 to 20 μm, 3 to 15 μm, 4 to 15 μm, or 6 to 12 μm.

In some embodiments, the outermost hardcoat layer or coating, after complete drying, has a thickness or an average thickness within the range of 0.6 micrometers (μm) to 10 μm or 1 μm to 8 μm, and more typically, within a range of 1.5 to 8 μm, 1.5 to 7.5 μm, 1.5 to 7 μm, 1.5 to 6 μm, 1.5 to 5 μm, 1.5 to 4.5 μm, 2 to 8 μm, 2 to 7 μm, 2 to 6 μm, 2 to 5 μm, 2 to 4.5 μm, 2 to 4 μm, 2 to 3.5 μm, 2.5 to 8 μm, 2.5 to 7 μm, 2.5 to 6 μm, 2.5 to 5 μm, 2.5 to 4 μm, 3 to 8 μm, 3 to 7 μm, 4 to 8 μm, 4 to 7 μm, 5 to 8 μm, 5 to 7.5 μm, or 5 to 7 μm.

In some embodiments, the at least one inner hardcoat layer or coating, as a wet layer, has a thickness or an average thickness within a range of 1 to 25 μm or within a range of 1.5 to 20 μm, and more typically, within a range of 1.5 to 15 μm, 1.5 to 10 μm, 1.5 to 7 μm, 1.5 to 5 μm, 2 to 10 μm, 2 to 7 μm, or 3 to 7 μm.

The inner coat layer or coating, after complete drying, typically has a thickness of within the range of 0.6 to 5 μm or 0.6 to 4 μm, and more typically, within a range of 0.6 to 3.5 μm, 0.6 to 3 μm, 0.6 to 2.5 μm, 0.8 to 2.2 μm, 0.8 to 2.0 μm, 0.8 to 1.8 μm, 0.8 to 1.6 μm, or 1.0 to 1.5 μm.

In some embodiments, the hardcoat formulations include one or more type of nanoparticles, e.g., for increased hardness or strength. Such nanoparticles may include boron nitride, B4C, cubic BC2N, silicon carbide, crystalline alpha alumina (sapphire); aluminum oxide Al2O3, silicon oxide SiO2, zirconium oxide ZrO2, titanium oxide TiO2, antimony oxide Sb2O5, tantalum oxide Ta2O5, zinc oxide, tin oxide SnO2, indium oxide, cerium oxide, Si3N4, and mixtures thereof; mixed oxides or composite particles, particularly those having a core/shell structure, and hetero-structured nanoparticle layers thereof.

Preferably, the nanoparticles are particles of aluminum oxide, tin oxide, zirconium oxide or silicon oxide SiO2, more preferably SiO2 nanoparticles. Mineral fillers are preferably used in colloidal form, i.e. in the form of fine particles dispersed in a dispersing medium.

Following drying/curing step 230, the method may include microvalving drops of a liquid film-forming post-hardcoat formulation onto an optical or ophthalmic surface of an optical or ophthalmic substrate, to form a wet layer (step 232). This may be followed by treating the wet layer to produce a dried transparent post-hardcoat layer on the optical surface (step 234). These steps have been described hereinabove in a general fashion, with respect to steps 102 and 104.

Such post hardcoat layers may include at least one of the following functionalities:
anti-wetting layer
anti-reflective layer
super hydrophobic/anti-fog layer
super hydrophilic/anti-fog layer
anti-glare layer
blue light.

It will be appreciated by those of skill in the art that these post-hardcoat formulations may also be applied by inkjetting or by conventional coating processes such as spin coating and dip coating.

FIG. 2A provides optional steps for the schematic block diagram of FIG. 2, in which the pre-treatment includes applying a liquid primer formulation to the exposed (lens) surface of the ophthalmic substrate. The wet primer layer or coating is subsequently dried, or allowed to dry, to obtain a dried (cured) primer layer or coating.

The liquid primer formulation may be applied using various conventional technologies, such as spin coating, slit coating, and dip coating.

In some embodiments, the primer is microvalved onto the exposed surface of the ophthalmic substrate, as will be described in greater detail hereinbelow.

In some embodiments, the primer pre-treatment is directed to facilitate wetting of the hardcoat layer or subsequently-applied layer with respect to the lens surface.

In some embodiments, the primer pre-treatment is directed to facilitate adherence of the hardcoat layer with respect to the lens surface.

In some embodiments, the primer is a polymeric primer.

In some embodiments, the polymeric primer is in the form of a waterborne emulsion (e.g., an acrylic emulsion).

In some embodiments, the polymeric primer is in the form of a solution (e.g., a polyurethane resin solution).

In some embodiments, the wet primer layer has at least one of a thickness and an average thickness within a range of 0.2 to 5 μm or within a range of 0.2 to 3 μm, and more typically, within a range of 0.2 to 2.5 μm, 0.3 to 2 μm, 0.4 to 2 μm, 0.4 to 1.5 μm, 0.5 to 2 μm, 0.5 to 1.8 μm, 0.5 to 1.5 μm, or 0.5 to 1.2 μm.

In some embodiments, the dried or dry primer layer has at least one of a thickness and an average thickness within a range of 0.2 to 4 μm or within a range of 0.2 to 2.5 μm, and more typically, within a range of 0.2 to 2 μm, 0.2 to 1.5 μm, 0.3 to 2 μm, 0.3 to 1.5 μm, 0.4 to 2 μm, 0.4 to 1.8 μm, 0.4 to 1.5 μm, or 0.4 to 1 μm.

With reference again to FIG. 3, FIG. 3 provides a schematic, general block diagram of a method of treating an optical surface to produce an optical construction, according to aspects of the present invention. Steps 306, 307, 308 and 310 may be substantially identical to steps 206, 207, 208 and 210 described hereinabove.

In optional step 316, an ink formulation such as a colorant containing ink formulation may be applied to the surface of the optical substrate, either directly, or on top of a primer layer applied in optional surface treatment 308.

In some embodiments, the ink formulation is a photochromic ink formulation containing at least one photochromic dye, and a polymeric binder.

In some embodiments, the ink formulation or photochromic ink formulation may be microvalved or microvalved onto the surface of the optical substrate.

In some embodiments, the ink formulation or photochromic ink formulation may be inkjetted onto the surface of the optical substrate.

In some embodiments, the ink formulation or photochromic ink formulation may be applied by at least one of dip coating, spin coating and slit coating.

The layer obtained may be dried, as needed, and cured to produce a cured ink layer or a cured photochromic ink layer (step 318).

In some embodiments, the photochromic dye containing layer, after complete drying and curing, has a thickness or an average thickness within the range of 0.6 to 40 μm or 1 to 40 μm, and more typically, within a range of 1.5 to 40 μm, 1.5 to 30 μm, 1.5 to 15 μm, 1.5 to 10 μm, 1.5 to 8 μm, 1.5 to 6 μm, 1.5 to 4 μm, 2 to 40 μm, 2 to 30 μm, 2 to 15 μm, 2 to 10 μm, 2 to 8 μm, 2 to 6 μm, 2.5 to 30 μm, 2.5 to 20 μm, 2.5 to 12 μm, 2.5 to 8 μm, 2.5 to 6 μm, 3 to 40 μm, 3 to 15 μm, 3.5 to 40 μm, 3.5 to 25 μm, 3.5 to 15 μm, 3.5 to 12 μm, 3.5 to 8 μm, or 3.5 to 6 μm.

The inventors have found that various hardcoat formulations may dissolve or otherwise attack the colorant containing ink layer, and more specifically, the photochromic dye containing layer formed and cured in steps 316 and 318. However, the inventors have further discovered that by applying an overcoat layer (step 320) on top of this colorant containing ink layer and effecting drying/curing (step 322), such attack may be inhibited or appreciably mitigated.

In some embodiments, the first overcoat layer, as a wet layer, has a thickness or an average thickness within a range of 1.5 to 40 μm or within a range of 2.5 to 40 μm, and more typically, within a range of 3 to 30 μm, 3 to 25 μm, 4 to 25 μm, 3 to 20 μm, 3 to 15 μm, 4 to 15 μm, or 6 to 12 μm.

In some embodiments, the first overcoat layer, as a dry layer, has a thickness or an average thickness within a range of 1 to 20 μm or within a range of 1 to 15 μm, and more typically, within a range of 1 to 12 μm, 1 to 10 μm, 1 to 7 μm, 1 to 6 μm, 1.5 to 7 μm, 1.5 to 6 μm, 1.5 to 5 μm, 1.5 to 4 μm, 2 to 7 μm, 2 to 5 μm, or 2 to 4 μm.

In some embodiments, the first overcoat layer is a thermoplastic polymer.

In some embodiments, the first overcoat layer is a thermoset polymer.

In some embodiments, the first overcoat formulation is a polymer emulsion.

In some embodiments, the first overcoat formulation is a polymer dispersion.

In some embodiments, the first overcoat formulation includes an acrylic polymer.

In some embodiments, the first overcoat formulation includes polyurethane.

In some embodiments, the material of the dry or completely cured overcoat layer has a König hardness of at least 80 (seconds). More typically, this König hardness is within a range of 80 to 180, 80 to 160, 90 to 180, 100 to 160, 100 to 150, 100 to 140, 110 to 180, 110 to 160, or 110 to 150.

Steps 324, 326, 328, 330, 332 and 234 of FIG. 3 may substantially correspond to steps 224, 226, 228, 230, 232 and 234 of FIG. 2, and have been described hereinabove.

In some embodiments, the hardcoat coating, after complete drying, has a thickness or an average thickness within the range of 0.6 micrometers (μm) to 10 μm or 1 μm to 8 μm, and more typically, within a range of 1.5 to 8 μm, 1.5 to 7.5 μm, 1.5 to 7 μm, 1.5 to 6 μm, 1.5 to 5 μm, 1.5 to 4.5 μm, 2 to 8 μm, 2 to 7 μm, 2 to 6 μm, 2 to 5 μm, 2 to 4.5 μm, 2 to 4 μm, 2 to 3.5 μm, 2.5 to 8 μm, 2.5 to 7 μm, 2.5 to 6 μm, 2.5 to 5 μm, 2.5 to 4 μm, 3 to 8 μm, 3 to 7 μm, 4 to 8 μm, 4 to 7 μm, 5 to 8 μm, 5 to 7.5 μm, or 5 to 7 μm.

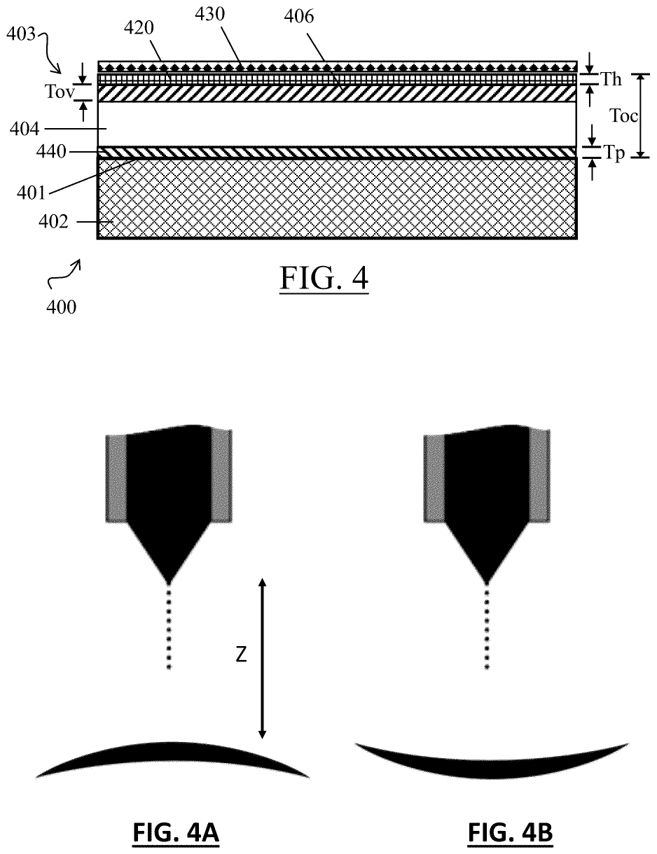

FIG. 4 is a schematic cross-sectional view of a multi-layered optical or ophthalmic device, component or structure 400, which includes an optical or ophthalmic substrate 402 having an optical or ophthalmic construction 403 fixedly attached to a broad surface 401 of the optical or ophthalmic substrate 402. Construction 403 further includes a primer layer 440 disposed between broad surface 401 and colorant layer 404. The thickness of primer layer 440 is designated as Tp. Above colorant layer 404 may be disposed an overcoat layer 406, substantially as described hereinabove. The thickness of overcoat layer 406 is designated as Tov. Above overcoat layer 406 may be disposed one or more hardcoat layers 420, according to further features of the present invention. Above hardcoat layer(s) 420, whose thickness is designated as Th, one or more post-hardcoat layers 430 may be disposed. The entire thickness of optical construction 403 is designated as Toc.

In some embodiments, the hardcoat layer has at least one of a wet thickness and an average wet thickness within a range of 1 to 50 μm, 1 to 40 μm, or 1 to 30 μm, and more typically, within a range of 1 to 25 μm, 1 to 20 μm, 1.2 to 15 μm, 1.2 to 12 μm, 1.2 to 10 μm, or 1.5 to 8 μm.

In some embodiments, the dry or cured hardcoat layer has at least one of a thickness Th and an average thickness Th-a within a range of 0.6 to 7.5 μm or 0.8 to 5.5 μm, or within a range of 0.8 to 5 μm, and more typically, within a range of 0.8 to 4.5 μm, 0.8 to 4 μm, 0.8 to 3.5 μm, 1 to 3.5 μm, 0.8 to 3 μm, 1 to 3 μm, 1.2 to 4.5 μm, 1.2 to 4 μm, 1.2 to 3.5 μm, or 1.2 to 3 μm.

With regard to the entire thickness Toc of optical construction 403, in some embodiments, the dry (cured) optical construction has an average thickness within the range of 1 to 50 μm, 1 to 40 μm, 1.5 to 30 μm, 1.5 to 20 μm, 1.5 to 15 μm, 2 to 40 μm, 2 to 30 μm, 2 to 25 μm, 2 to 20 μm, 2 to 15 μm, 2.5 to 15 μm, 3 to 30 μm, 3 to 20 μm, 3 to 15 μm, 3 to 12 μm, 4 to 30 μm, 4 to 15 μm, 5 to 25 μm, 5 to 20 μm, 5 to 15 μm, 5 to 12 μm, 7 to 35 μm, 7 to 25 μm, 7 to 20 μm, or 7 to 15 μm.

As schematically provided in FIGS. 4A and 4B, a microvalve apparatus may be utilized to jet ink drops onto surfaces of different contours, including a convex lens surface (FIG. 4A) and a concave lens surface (FIG. 4B).

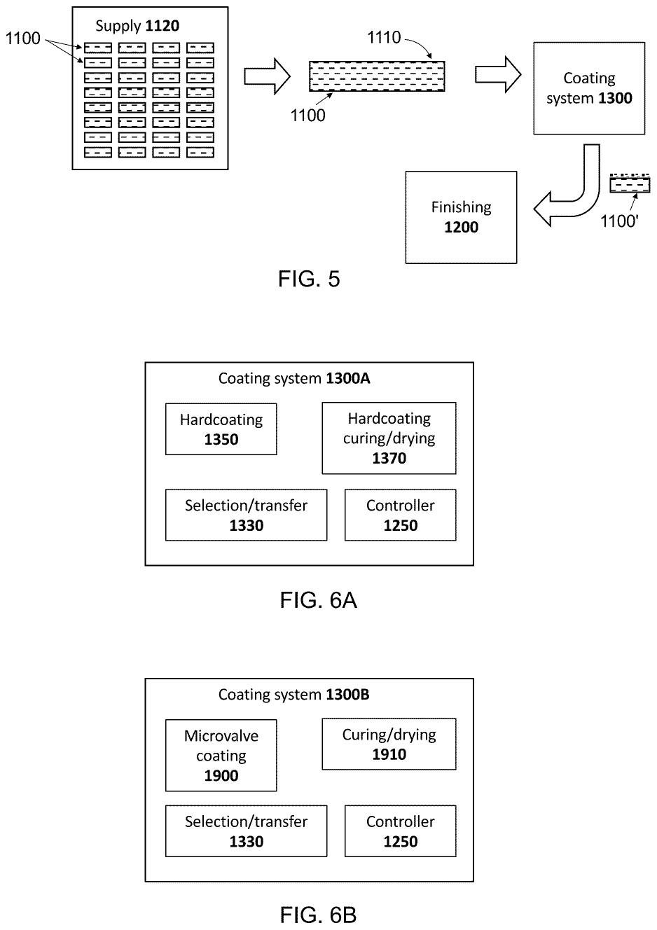

FIG. 5 schematically illustrates selected steps of a process for coating an optical or ophthalmic substrate (OS) 1100, for example a lens blank, using a coating system 1300.

Examples of OS 1100 (e.g. to apply thereon one or more coating using any teaching or combination of teachings disclosed herein) include but are not limited to: (i) eyeglass lenses; (ii) Single-Vision Lenses; (iii) Multifocal Lenses; (iv) Anti-fatigue lenses (e.g. including a single-vision prescription and a boost of magnification at the bottom of the lens); (v) Progressive lenses (e.g. designed to correct for multiple viewing distances-including far, intermediate and near—in one lens); (vi) Prism Lenses; (vii) Spherical lenses; (viii) Cylindrical lenses. Other examples of OS 1110 include lenses of a virtual-reality (VR) device including but not limited to VR glasses or VR goggles.

Element 1110 schematically represents a target surface of an optical substrate 1100 to be coated with at least one dried layer, e.g. multiple dried layers stacked directly or indirectly on each other. For example, an optical substrate (OS) 1110 may correspond to optical or ophthalmic device, component or structure 400 (e.g. an uncoated version or partially uncoated version thereof). For example, the target surface 1110 may correspond to surface 401, or to any other surface of any other layer of FIG. 4.

For example, the target surface 1110 may correspond to the ‘outward-facing surface’, i.e. that which will face away from the wearer of the glasses of an eyeglass lens.

Target surface 1110, before being modified by coating system 1300, may be uncoated or may be pre-coated, e.g. before ‘delivery’. In contrast, coated substrate OS 1100′ has a coated version of target surface 1110—i.e. after a coating is applied by coating system 1300.

In embodiments, an optical coating system 1300 may be employed to provide ‘customization’ of optical articles-of-manufacturing (e.g. eyeglasses). For example, optical coating system 1300 may be deployed in a factory or in a store-front, e.g., of an optometrist. For example, optical coating system 1300 may include, or may be in communication with, a digital computer (not shown), which stores and/or includes directives for producing a customized optical article-of-manufacturing.

In one non-limiting use-case, a customer having a certain optical prescription may require one or more of, e.g. any combination of: (i) specific tint or target color—i.e. to customize her/lens to a specific color; and/or (ii) a specific physical or characteristic such as, e.g. abrasion resistance; and/or (iii) a presence or absence of photochromatic features; and/or (iv) a desired glossiness; and/or (v) a desired presence or absence of varnish.

The manufacturing of the lens geometries, e.g. to satisfy a certain optical prescription and/or shape, may optionally be carried out ‘off site’ in a different location from where the coating system 1300 is deployed.

Since the possible combinations of articles-of-manufacturing could be very large such as many types of lens geometries, multiple types of ‘color features’ for coating a lens, or target colors to coat the lens, target digital pixel-patterns of lenses, etc., it may not be practical to maintain an inventory of ‘every possibility.’

Instead, it may be desirable to maintain a supply 1120 of multiple types of ‘raw material’ substrates 1100 based on lens geometry. Thus, a specific workpiece such as OS 1100 may be selected from a plurality of candidates, which can optionally be stored in a digital computer, according to specified geometric properties such as, for example g. properties expressed as an optical prescription. An ‘input’ OS 1100 may be selected by rejecting some candidate in favor of a ‘preferred candidate’ OS 1100 whose geometric properties best match required lens-geometry and/or refractive index and/or multi-focal directive and/or astigmatism directive and/or optical prescription data.

The coated OS 1100′, such as an eyeglass blank or an eyeglass lens can be cut and/or installed into eyeglass frames in a lens-cutting and/or glasses-frame installing apparatus 1200.

OS 1100, in some embodiments, is rigid—e.g. having an average thickness (alternatively or additionally, a thickness in at least one location of OS 1100) that is at least 0.5 mm or at least 1 mm or at least 2 mm or at least 3 mm).

As will be discussed below, a coating system 1300 in various embodiments apply one or more dried layers of optionally transparent material dried layer of material or multiple dried layers onto or over surface 1110 of OS 1100.

The combination of: (A) operating parameter(s) of coating system 1300 and/or (B) physical and/or chemical properties of materials (e.g. viscosity and/or fraction of solids and/or surface-energy, employed by any implementation or embodiment of coating system 1300 may be such that the layers, i.e. dried and/or transparent layers produced on or over surface 1110 of OS 1100, have one or more specific properties.

Such properties include, but are not limited to, (i) thickness of a particular dried transparent layer or ratios between different transparent layer ratios (ii) area over which the transparent layer or a convex subportion thereof is continuous over the entirety of the area of convex subportion thereof; (iii) color and/or optical density of any dried layer; (iv) mechanical properties of any dried layer or combination of layer(s). Thus, system 1300 may be configured to manufacture on surface 1110 of OS 1100 to obtain any property or combination of properties of wet or dried layers disclosed herein.

As will be discussed below, operating parameters of coating system 1300 or any one or more of its components, including components controllable, e.g., by controller 1250 (not shown in FIG. 5) can include, without limitation: (i) parameters for microvalving or inkjetting drops (or, equivalently as used herein: droplets) such as, for example, drop velocity, drop-deposition frequency, drop size and/or volume, spacing between droplets, or any other operating parameter for depositing drop or droplets, drop or droplet ejection-speed, and gap-distance between a nozzle of a microvalve or inkjet device and target surface 1110; (ii) drying time or drying temperature or drying intensity or power or any other parameter related to drying of a wet layer such as, for example, oven temperature, parameters of convective and/or radiative drying such as, for example, UV intensity; (iii) relative motion between any nozzle for delivering drops or droplets and target surface 1110; (iv) properties related to treating surface 1110 of OS 1100, e.g. to obtain a desired surface-energy or an energy in a certain range; (v) selection of a formulation, or a container, cartridge or reservoir of the formulation, from a plurality of candidates and/or mixing of a formulation; and ventilation operating parameters.

In different embodiments, the term ‘apparatus’ may refer to a specific station (e.g. drying station and/or wet layer-application station for any wet layer). Thus, any reference to ‘apparatus’ may also be taken as (i.e. in embodiments of the invention) a ‘station’.

In various embodiments, the components of optical coating system 1300 are configured and/or arranged to perform any method described here in (e.g. reference to FIGS. 1-3—all steps or any combination of step(s) to provide any feature of combination of feature(s)—not all steps are required.

The resulting coated OS 1100′ may include any dry layer or combination of layers or feature(s) thereof or combination(s) thereof taught with reference to FIG. 4 (not all layers are required)—the layers produced and properties thereof (e.g. within the framework of FIG. 4) are according to the specific elements (and their operating parameter(s) and formulation(s)) of a specific implementation of coating system 1300—we note various versions of system 1300 are described herein.

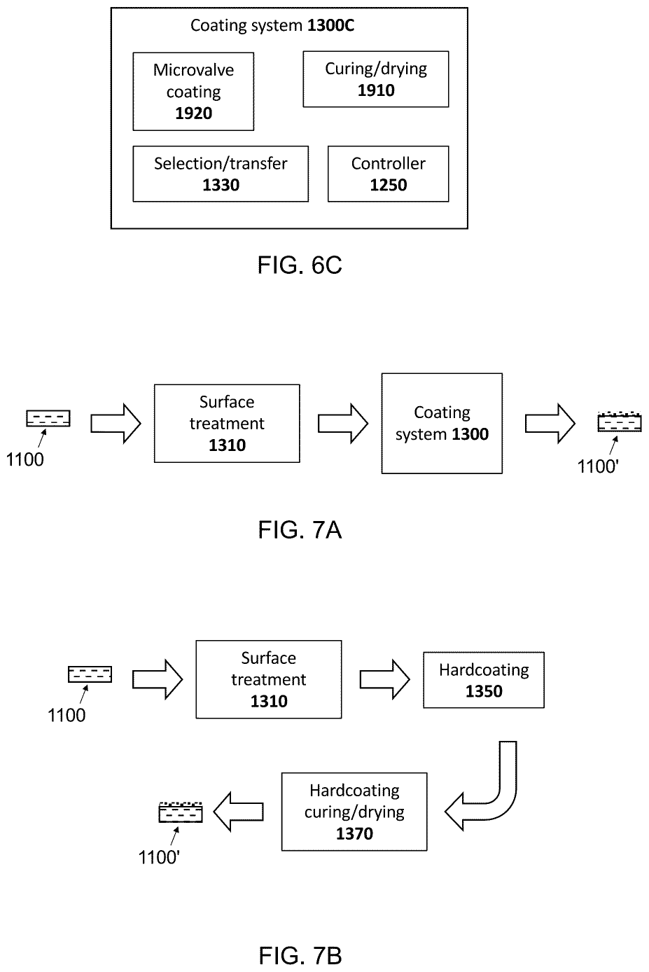

Various examples and/or embodiments of coating systems 1300 and/or processes related to coating systems are schematically presented in FIGS. 6A-6C, 7A-7B, 8, 9, 10A-10C, and 11 as block diagrams and/or flow-diagrams illustrating various systems and methods according to various embodiments of the disclosure.

FIG. 6A shows a block diagram of an exemplary coating system 1300A. The coating system 1300A can include any one or more (or all) of (i) a hardcoating-formulation application apparatus 1350 for applying a coating or layer of a hardcoating formulation e.g. by microvalving, (ii) hardcoat-drying and/curing apparatus 1370 for drying and/or curing a wet layer of a hardcoat formulation, (iii) selection and/or transfer apparatus 1330, and a (IV) controller 1250. In some embodiments, the hardcoat formulation comprises an ink, e.g., for tinting and/or photochromic tinting, and/or an electrochromic ink. The wet layer can be ‘thin’, characterized by having a thickness of at most 100 or 90 or 75 or 50 or 25 or 20 or 15 or 10 microns.

FIG. 6B shows a block diagram of another exemplary coating system 1300B. The coating system 1300B can include any one or more (or all) of (i) a microvalve-based coating apparatus 1900 for coating a surface of an optical substrate 1100, configured, for example, to coat on the surface 1110 of optical substrate 1100 by microvalving liquid drops to form one or more thin layers of a formulation. Such a thin layer can be characterized by having a thickness of at most 100 or 90 or 75 or 50 or 25 or 20 or 15 or 10 microns. (ii) drying and/or curing apparatus 1910, (iii) selection and/or transfer apparatus 1330, and (iv) a controller 1250. In an example, one or more wet layers applied by microvalve-based coating apparatus 1900 are subjected to a drying and/or curing process by drying and/or curing apparatus 1910. Examples of the ‘formulations’ which can be applied by microvalve-based coating apparatus 1900 are: (i) hard-coating formulations which may be microvalved to produce a layer of the hard-coating formulation, (ii) ink-formulations, e.g., for tinting or photochromic and/or electrochromic ink to produce a layer of the ink formulation; (iii) surface-energy-increasing formulations which may be microvalved to produce a layer of the surface-energy-increasing formulation so as to increase the surface energy of the target surface 1110 of the optical substrate 1100.

In embodiments related to FIG. 6B, one of more of the features can be provided by the coating system 1300B (or elements thereof): (i) microvalve-based coating apparatus 1900, forms by microvalving drops onto target surface 1110, one or more continuous wet layers, which may be stacked by drying a preceding layer; (ii) microvalve-based coating apparatus 1900 for forming, by microvalving drops onto the target surface 1110, a continuous wet layer that is thin-characterized by having a thickness of at most 100 or 90 or 75 or 50 or 25 or 20 or 15 or 10 microns; and (iii) drying and/curing apparatus 1910 which transforms continuous wet layer into a continuous dry layer for one layer or for multiple stacked layers.

The skilled artisan will appreciate that microvalve-based coating apparatus 1900 may deliver only one such layer or may deliver a plurality of such layers such that layers are stacked on each other. For example, it can be that a first layer may first be dried by the drying and/or curing apparatus 1910 before a second layer is applied directly or indirectly over the first layer.

The exemplary coating system 1300C of FIG. 6C is a specific example of coating system 1300B of FIG. 6B where multiple layers are stacked on each other on upper target surface 1110 of optical substrate 1100. At least one of such layers is produced by microvalving drops—e.g. by microvalve based coating apparatus 1900 or 1920.

Reference is now made to FIG. 7A. In the example of FIG. 7A, an optical substrate 1100 is first treated by surface-energy-increasing apparatus 1310 to increase the surface energy of the target surface 1110 before coated by the coating system 1300A or any other coating system 1300 disclosed herein to apply one or more layers, e.g., with a hardcoating formulation.

FIG. 7B is another example of a coding system where optical substrate 1100 is first treated by surface-energy-increasing apparatus, and subsequently coated by hardcoating-formulation application apparatus 1350 to apply a wet layer and/or coating of a hardcoating formulation. This wet layer and/or coating of a hardcoating formulation is subsequently dried and/or cured by hardcoat-drying and/or curing apparatus 1370, to yield coated optical substrate 1100′. The system of FIG. 7B may also including (i) selection and/or transfer apparatus 1330 and/or (ii) a controller 1250.

According to embodiments, a coating system 1300 may include any one or more of the following components:

One or more controllers 1250: for simplicity, only a single controller 1250 is shown in the various drawings. A controller 1250 can regulate operating parameters of any other element of a coating system 1300, including, but not exhaustively: microvalving apparatus, drying apparatus, ink-jet apparatus, transfer apparatus, or any other apparatus or combination if present. The controller 1250 may be part of and/or be located in the coating system 1300 or in any of the components, and/or may be located separately and/or remotely. Controller 1250 may include any electrical and/or electronic components required to perform its function of controlling any component or combination of components.

In some embodiments of the invention, any coating system 1300 disclosed herein may include data-acquisition and/or monitoring apparatus 1430 such as, for example, imaging and/or inspection components. A controller 1250 may directly or indirectly receive data from such data-acquisition and/or monitoring apparatus 1430.

Hardcoating-formulation application apparatus 1350 microvalves drops of hardcoat formulation onto the target surface 1110 of an OS 1100 in order to produce on the surface 1110 a wet layer of hard coat formulation from the microvalved droplets of hardcoat formulation. The hardcoating apparatus 1350 can be in communication with and/or loaded with a hardcoating formulation. In any of the embodiments of the coating system, a formulation, including without limitation a hardcoating formulation, can be disposed within a cartridge or any other container or reservoir.

The hardcoating formulation employed by the hardcoating apparatus 1350 may be in accordance with any hardcoat formulation teaching disclosed herein or any combinations of the teachings. As already disclosed hereinabove, the hardcoating formulation employed by a microvalve-based apparatus, e.g., microvalving apparatus 1900, can optionally also be an ink.

In various embodiments, hardcoating apparatus 1350 may be configured and/or regulated by the controller 1250 to produce a wet layer of hardcoat formulation having specific properties. For example, the wet layer can comprise a sub-100μ wet layer of hardcoat formulation. For example, the wet layer can have a thickness of at most 90 microns or at most 75 microns or at most 50 microns or at most 25 microns or at most 20 microns or at most 15 microns or at most 10 microns. For example, the wet layer may be continuous at least over a certain area (e.g. at least over a convex region having a specific area—e.g. at least 1 cm\hat{ }2 or at least 2 cm\hat{ }2 or at least 4 cm\hat{ }2 or at least 8 cm\hat{ }2).

In various embodiments, apparatus 1350 is configured, e.g., by controller 1250 and/or by formulation properties to perform step 102 of FIG. 1 and/or step 224 of FIG. 2.

Hardcoat-drying and/or curing apparatus 1370 can be provided and configured for applying thermal energy to a wet layer of hardcoat formulation such as that produced by hardcoating apparatus 1350 and having a thickness or any other properties taught herein, to convert this wet layer in hardcoat formulation into a dried hardcoat layer having any property disclosed herein. In various embodiments, the hardcoating apparatus 1350 is configured, e.g., by the controller 1250 and/or by formulation properties to perform step 102 of FIG. 1 and/or step 224 of FIG. 2.

Selection and/or transfer apparatus 1330 for selecting and/or providing relative motion of OS 1110 relative to any apparatus and/or unit and/or station of 1300 or component thereof. This ‘relative motion’ may transport, e.g., by translation and/or rotational motion, the OS 1100 or portion thereof and/or any apparatus and/or component and/or station of the coating system 1300 relative to the OS 1100.

In different embodiments, selection and/or transfer apparatus 1330 may be controlled at least in part by the controller 1250, e.g. to achieve a directive stored in a digital computer, such as, for example a target property of hardcoating layer.

In various embodiments, selection and/or transfer apparatus 1330 may include one or more of: a robotic arm, a gripper, a conveyer belt, and an elevator for raising or lowering an elevation of the optical substrate and the wet layer on the target surface thereof.

Selection and/or transfer apparatus 1330 may be configured for such relative motion between components of coating system 1300 and/or for selecting an OS 1110 from a plurality of candidates according to a directive in computer storage and/or read by a digital computer such as, for example, an optical prescription.

Microvalve-based coating apparatus 1900 or 1920: any wet layer disclosed herein may be applied by microvalving apparatus 1900, which in embodiments can be controlled by the controllers 1250, as in, for example, step 102 of FIG. 1. The operating parameters of 1900 may depend on the specific layer to be formed or the formulation from which this layer is produced. Thus, apparatus 1900 may, in different embodiments, perform step 224 of FIGS. 2 and/or 228 of FIGS. 2 and/or 310 of FIG. 2A and/or 324 of FIG. 3 and/or step 228 of FIG. 3.

A coating system may include a single instance of microvalving apparatus 1900 or 1920 configured to operate in accordance with multiple sets of operating parameters depending on the wet layer to be dried/converted into a dry layer.

Any dried layer disclosed or claimed herein, for example a dried layer produced by any method or system disclosed herein, e.g., by step 104 of FIG. 1 or step 210/310 of FIG. 2/3 or step 226/326 of FIG. 2/3 or step 230/330 of FIG. 2/3 or step 234/334 of FIG. 2/4 and/or produced by element 1370 or 1910 or 1420 or 1530 or element 1630 or element 1650 or element 1670) may be considered continuous and/or thin as the terms are defined herein.

A ‘continuous’ dried layer is one that is continuous over an entirety of a virtual convex-region as schematically illustrated, for example, in FIG. 12D, where region 1962, region 1966, and region 1968 are examples of convex regions while region 1964 is a counter-example. In examples, the area of a convex-region of target surface 1110 may be, in different embodiments, at least 0.5 cm² or at least 1 cm² or at least 2 cm² or at least 4 cm² or at least 8 cm² or at least 10 cm² or at least 20 cm²).

The boundaries of the region are ‘virtual’ rather than any physical boundaries-thus, the term ‘convex region’ refers to the shape of these ‘virtual’ boundaries rather than to any geometric property of the physical topography of target surface 1110 of optical substrate 1100.

Thus, as shown in FIGS. 12B and 12C, even when topographically surface 1100 is completely concave as in FIG. 12C, it is possible to define thereupon, by defined/virtual boundaries, a convex-portion or convex-region within the topographically-concave surface 1100.

A thickness of a ‘thin’ dried layer is at most 20 microns or at most 15 microns or at most 10 microns or 5 microns or at most 3 microns or at most 1 micron.

In any embodiment disclosed herein, any ‘dried layer’ formed from a ‘wet layer formed by microvalved-drops’ is sourced at least 75% wt/wt or at least 80% wt/wt or at least 90% wt/wt from the microvalved droplets.

In any embodiment disclosed herein, any ‘dried layer’ produced from a ‘wet layer formed by drops primarily in the [r mm, s mm] (r and s are both positive numbers, mm is millimeters) range’ is a dried layer that is sourced at least 75% wt/wt or at least 80% wt/wt or at least 90% wt/wt from drops (i.e. to produce the precursor wet layer which is then dried) whose width is both at least r mm and at most s mm. In different embodiments, any dried layer disclosed herein is formed primarily from drops in the [0.1 mm, 3 mm] range.

In various embodiments, any dried layer disclosed herein is formed primarily from drops in the [0.1 mm, 2 mm] range. In different embodiments, any dried layer disclosed herein is formed primarily from drops in the [0.1 mm, 1.5 mm] range. In different embodiments, any dried layer disclosed herein is formed primarily from drops in the [0.1 mm, 1 mm] range. In different embodiments, any dried layer disclosed herein is formed primarily from drops in the [0.01 mm, 1 mm] range. In different embodiments, any dried layer disclosed herein is formed primarily from drops in the [0.15 mm, 3 mm] range. In different embodiments, any dried layer disclosed herein is formed primarily from drops in the [0.2 mm, 1 mm] range.

Alternatively or additionally, multiple instances of 1900 or 1920 may be provided, each for drying a different wet layer of formulation and each operating according to different operating parameters.

(A) A drying and/or curing apparatus 1910 can include, in different implementations, an oven and/or UV apparatus or other element for converting a wet layer of formulation into a dried layer, including, optionally, a transparent layer. The operating parameters of the drying and/or curing apparatus 1910 depend upon the specific formulation and its properties. For example, for a hardcoating formulation, a drying temperature and/or energy and/or duration required/employed may exceed that required/employed for a ‘primer formulation.’ Any coating system 1300 may include a single 1910 or multiple drying and/or curing apparatus 1910 and the operating parameter(s) thereof depend on the formulation and/or structure of the specific wet layer to be converted into a dry layer.

In various embodiments, a drying and/or curing apparatus 1910 can be configured to perform step 104 of FIG. 1 and/or step 207 or FIG. 2 and/or step 210 of FIG. 2 and/or step 226 of FIG. 2 and/or step 230 of FIG. 2 and/or step 234 of FIG. 2 and/or step 320 of FIG. 2A and/or step 307 of FIG. 3 and/or step 310 of FIG. 3 and/or step 326 of FIG. 3 and/or step 330 of FIG. 3 and/or step 334 of FIG. 3.

(B) A surface-energy-increasing apparatus 1310, as shown in further detail in FIG. 9, can be provided for increasing a surface energy of a target surface 1110 of the optical substrate 1100. In various embodiments, surface-energy-increasing apparatus 1310 operates to increase the surface energy of target surface 1110 of OS 1100 by at least 2 mN/m, or at least 3 mN/m, or at least 5 mN/m, or at least 8 mN/m, or at least 12 mN/m. Alternative or additionally, the surface-energy-increasing apparatus 1310 operates to increase the surface energy of target surface 1110 of OS 1100 by at most 40 mN/m, or at most 30 mN/m, or at most 20 mN/m, or at most 17 mN/m, or at most 14 mN/m. FIG. 7C-7E illustrate non-limiting examples of coating systems 1300 that include surface-energy-increasing apparatus 1310. In different examples, as shown in the block diagram of FIG. 9, surface-energy-increasing apparatus 1310 includes plasma-treatment apparatus 1501A and/or corona-treatment apparatus 1510B and/or electron-bean apparatus 1510C and/or electron-discharge apparatus 1510D. Alternatively or additionally, apparatus 1310 includes (i) a drop- and/or droplet-deposition device 1520 (e.g. microvalve or inkjet loaded or in fluid communication with appropriate surface-energy-increasing formulation according to any of the teachings herein and (ii) a drying and/or curing apparatus 1530 operating at lower power and/or lower temperature and/or lower duration than that for drying the wet hardcoating layer, e.g., because of the wet layer of the surface-energy-increasing formulation. In various embodiments, apparatus 1310 is configured to perform step 208 of FIGS. 2 and/or 308 of FIG. 3. Alternatively or additionally, apparatus 1520 (i.e. any instance thereof-if present) is configured to perform step 310 of FIG. 2A.

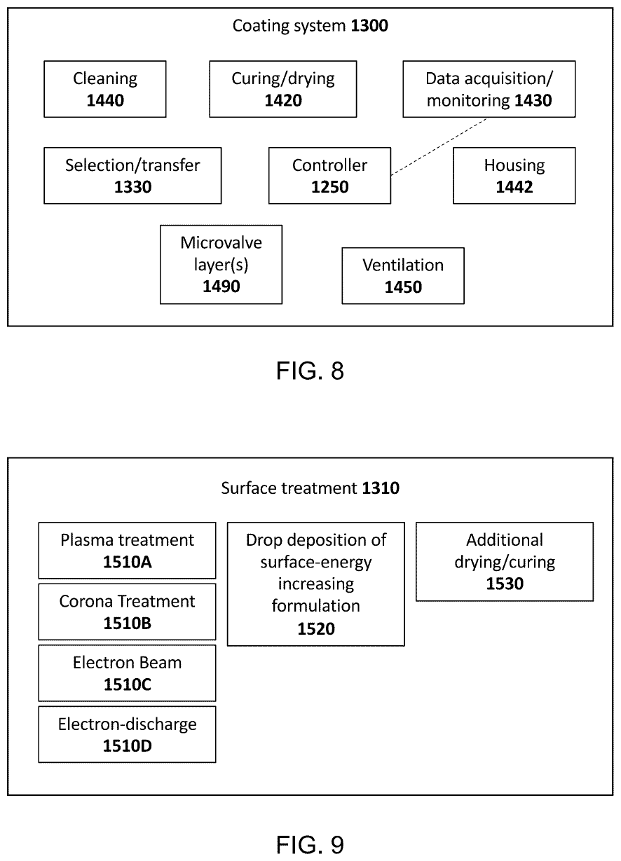

(C) With respect to the microvalve application apparatus 1490 and additional drying and/or curing apparatus 1420 of FIG. 8, there may be more than one microvalve based layer-application apparatus. Similarly, there may be more than one drying apparatus as discussed elsewhere.

Still referring to FIG. 8, any coating system 1300 disclosed herein may include any of the following in any combination:
(i) Cleaning apparatus 1440 can be provided to treat the target surface 1110 of the optical substrate 1100, e.g., for surface-cleaning. For example, the cleaning apparatus 1440 can be configured to apply a washing solution and/or soap and/or a surfactant to the target surface 1110 of the optical substrate 1100. For example, the cleaning apparatus 1440 can be configured to dry an applied cleaning fluid and/or to subject the target surface 1110 to a dust-removal process. For example, the cleaning apparatus 1440 can treat the target surface 1110 before the target surface 1110 is subsequently subjected to a surface-energy-increasing process (e.g. by the apparatus 1310 or before the target surface 1110 is targeted for coating by any of the coating apparatuses disclosed herein.
(ii) Additional drying and/or curing apparatus(es) 1420—for example, in addition to 1370 or 1910. For example, multiple wet coatings may be applied to target surface 1110 of optical substrate 1100. For example, a first wet coating or coating-layer may be dried and/or curried by a first drying and/or curing apparatus (e.g. 1370 or 1910) and a second wet coating or coating-layer may be dried by element 1420.
(iii) Ventilation apparatus 1450;
(iv) Housing 1442;
(v) Microvalve-based additional-layer Application Apparatus(es) 1490—as noted above, there may be more than one microvalve based layer-application; and
(vi) Selection and/or transfer apparatus 1330 (e.g. for substrate and/or solvent and/or cartridge and/or other apparatus).

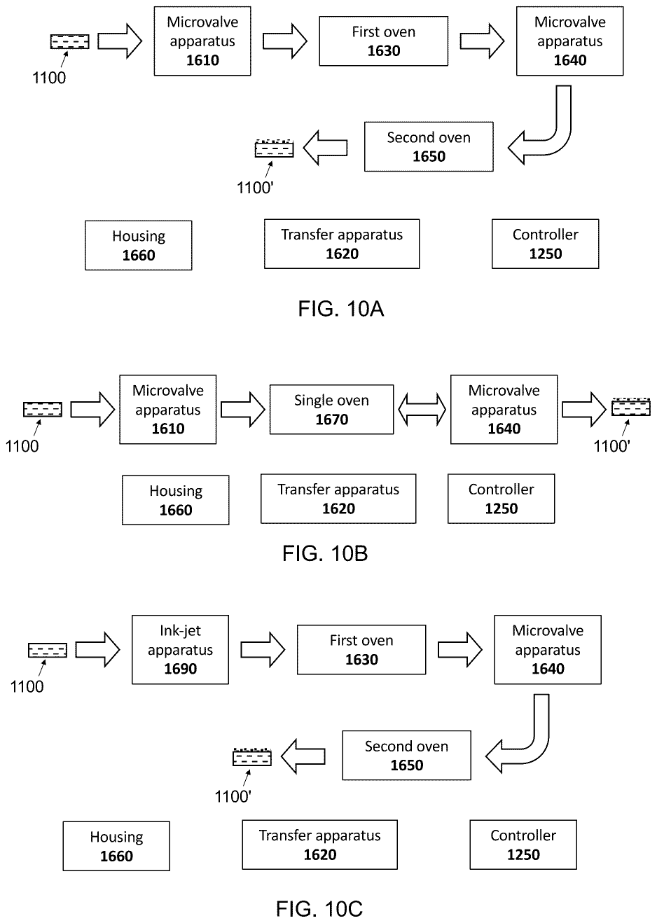

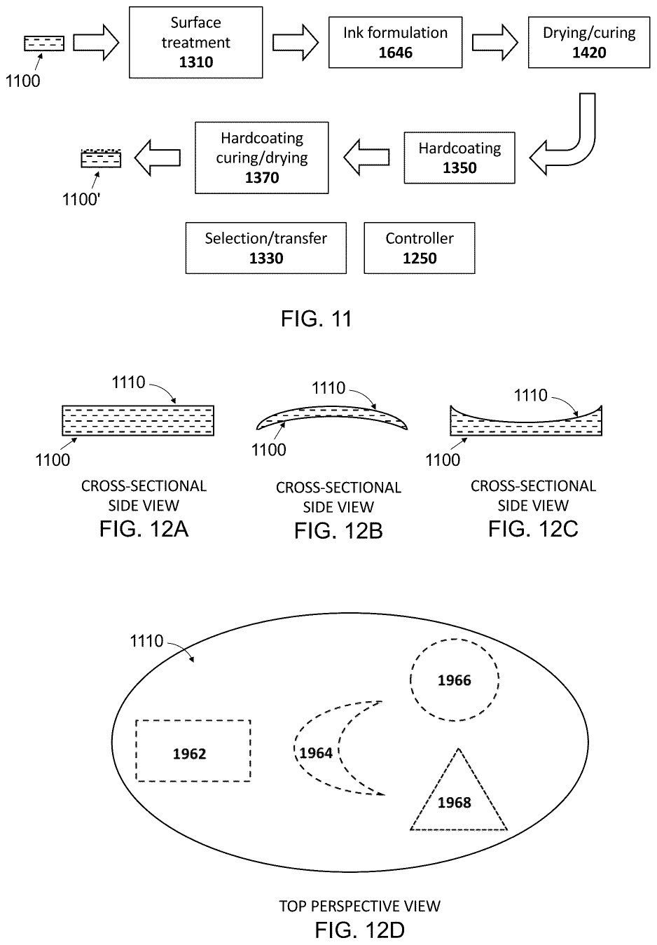

FIGS. 10A-10C and 11 schematically illustrate non-limiting examples of operating respective exemplary coating systems 1300 comprising one or more ovens for drying and/or curing a wet coating on an optical substrate 1100.

FIG. 10A illustrates an exemplary operating process as follows:
(i) A first microvalve apparatus 1610 in communication with and/or loaded with surface-energy-increasing formulation is provided for increasing the surface energy of target surface 1110 of an optical substrate 1100 so that drops that are microvalved to the surface 1110 collectively form a wet coating of the surface-energy-increasing formulation on the target surface 1110;
(ii) A first oven 1630 is provided, to operate a drying process at a ‘low’ temperature and/or short duration—i.e. for a drying process of relative ‘low’ duration) in order. to dry the wet coating delivered by microvalve apparatus 1610;
(iii) A second microvalve apparatus 1640 is provided for applying a second wet coating by microvalving drops of a second formulation—for example, a hardcoating-onto the target surface 1110 after the wet coating of the surface-energy-increasing formulation is dried by the first oven 1630; and
(iv) a second oven 1650 is provided for drying and/or curing the wet coating of the wet coating of the second formulation.

The example of FIG. 10B shows a setup comprising a single oven 1670 rather than multiple ovens. A first transfer of the optical substrate 1100 is made into the single oven 1670 for drying/curing the wet coating from the microvalve apparatus 1610. A first transfer is made out of the single oven 1670 after the first drying/curing process. A second transfer is made into the single oven 1670 to dry or cure the wet coating from second microvalve apparatus 1640. The requisite movement of substrate 1100 may be performed at least in part by the optical-substrate transfer apparatus 1602 and at least some of the movements can be made automatically or robotically.

FIG. 10C shows a third setup in which the coating is performed by an ink-jet apparatus 1690 instead of a microvalve apparatus. The setup and process are otherwise the same as that shown in FIG. 10A.

FIG. 11 shows a fourth setup similar to that of FIG. 7B with the addition of an ink-formulation apparatus 1646 and an ink-layer drying and/or curing apparatus(s) 1420.

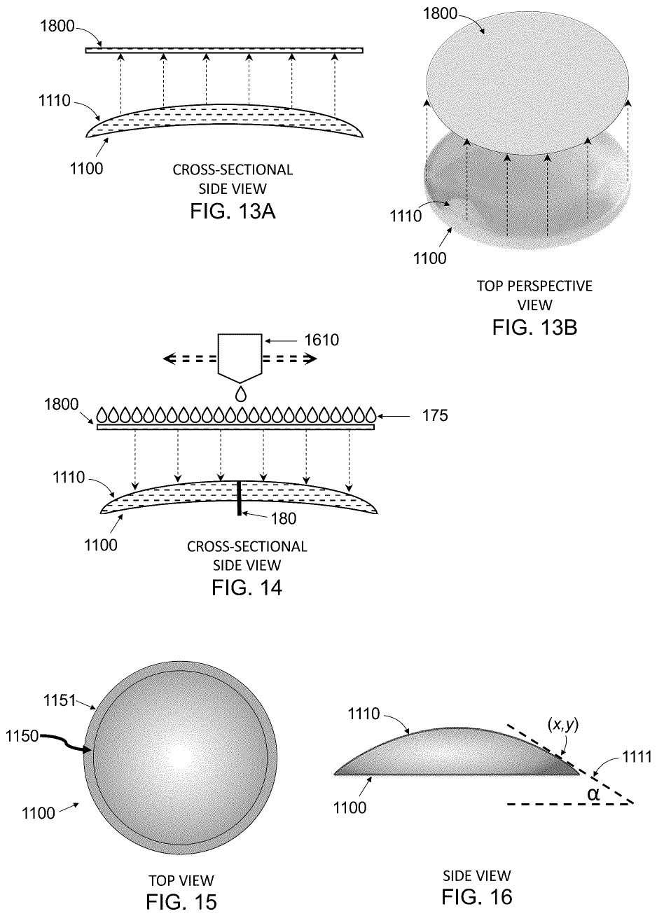

With reference now to FIGS. 13A, 13B, 14, 15 and 16, FIG. 13A shows a cross-sectional side view, and FIG. 13B shows a top perspective view, of a virtual two-dimensional projection 1800 of a curved surface 1110 of an exemplary optical substrate 1100. In embodiments, a coating system, such as any one of the coating systems 1300 disclosed herein comprising a controller 1250, can be configured to microvalve drops with a constant density in terms of volume of formulation per unit of area of the two-dimensional projection 1800. The term ‘constant density’ as used herein can mean exactly constant, or alternatively can mean within +10%, or within +5%, or within +2%, or within +1% of a mean value of the ‘density’, i.e., the volume of formulation per unit of area of the two-dimensional projection, ratio for the entirety of two-dimensional projection. The constant density or, in the alternative, the density within one of the given ranges from the mean, can be measured in a small area of the two-dimensional projection such as, for example, any subdivision of the two-dimensional projection 1800 having an area of 5% or more of an area of the projection 1800.

The applied formulation can include any one or more of the inks and/or coating formulations disclosed herein. In some embodiments, the formulation is selected, inter alia, for physical characteristics that make the formulation suitable for being deposited on curved surfaces in the manner described here.

The term ‘configured’ in the foregoing should be understood as including ‘programmed’ and/or ‘programmable’, i.e., that the controller 1250 is so programmed or programmable to control the microvalving apparatus accordingly.

In some embodiments, the controller 1250 can be programmed or programmable to generate the two-dimensional projection 1800 and/or to calculate or select a target value and/or mean value of the ratio of the volume of formulation per unit of area of the two-dimensional projection 1800.

Application of drops 175 of the formulation by a microvalving apparatus 1610 in a constant density vis-à-vis the two-dimensional projection is shown schematically in FIG. 14, although for the sake of clarity it should be noted again that the two-dimensional projection is a virtual one. The drops 175 are actually applied to the curved surface 1100, albeit being applied in a density or, equivalently, frequency, determined by the area of the two-dimensional projection 1800. As one can understand from the schematically illustrated geometry, the surface area of the curved surface 1110 is larger than the two-dimensional projection. Furthermore, the divergence of the area of the curved surface 1110 from that of the two-dimensional projection 1800 is larger in peripheral sections of the optical substrate 1100 than in central areas for the single-vision convex lens surface shown in the non-limiting example of FIGS. 13A-14. As is known, the degree of divergence of the area of the curved surface 1110 from that of the two-dimensional projection 1800 can be determined by the curve geometry of the curved surface, e.g., from curve geometry parameters such as the sagitta 180 of the surface 1110, the radius in the case of a spherical curve, and so on. Moreover, the actual density, i.e. the volume of formulation actually applied on the actual curved surface 1110 per unit of area of the curved surface 1110, is, typically, inversely proportional to the ratio of the area of the curved surface 1110 to the area of the two-dimensional projection, and this applies to any subdivision of the surface 1110 as well.

Accordingly, in some embodiments, depositing the formulation in a manner or distribution suitable to the particular formulation and curve geometry can be accomplished without requiring the application process to take into account the curve geometry when selecting or calculating a density of the application. Moreover, in some embodiments, the application of the formulation can cover an area greater than the surface of the optical substrate without requiring the application process to take into account other geometric parameters, such as the diameter or shape of the optical substrate.

FIG. 15 schematically shows an annular section 1150 at the periphery of an exemplary optical substrate 1100, which can be useful for characterizing the divergence of the area of the curved surface 1110 of the optical substrate 1100 from the corresponding area of the two-dimensional projection 1800, as well as for characterizing the reduced actual density on the actual curved surface 1110 as a function of distance from the center. In this non-limiting example, the annular section 1150 describes the area characterized by falling between 90% and 100% of the distance from a centroid of the optical substrate 1100 to the edge 1151. In an exemplary embodiment, the microvalving of the drops 175 of the formulation is controlled by the controller 1250 such that a ratio of a mean volume of formulation applied per unit of area of the curved surface 1110 in the outer annulus 1150 characterized by lying between 90% and 100% of a distance from a centroid of the curved surface 1110 and the perimeter 1151, is typically between 0.6 and 0.97 or 0.6 and 0.96 or 0.6 and 0.94 times a maximum ratio of a volume of formulation applied per unit of area of the curved surface 1100.

Referring now to FIG. 16, a virtual tangent line 1111 (or plane) is drawn at point (x,y) on the curved surface 1110 of the optical substrate 1110. The tangent line can be used to characterize the angle α of curved surface 1110, e.g., relative to the horizontal, and to describe the localized divergence of the area of the actual curved surface 1110 from the corresponding localized portion of the virtual two-dimensional projection 1800. In embodiments, the angle α can be between 5° and 50°, or between 10° and 40°, or between 5° and 20°, or between 20° and 50°, or within any intervening range between 5° and 50°. In embodiments, the microvalving of the drops 175 of the formulation is such that a ratio of a mean volume of formulation applied per unit of area of the curved surface 1110 at a given point on the surface 1110, is equal to a reduction factor times a maximum ratio of a volume of formulation applied per unit of area at any point on the surface 1100, said reduction factor being equal to a cosine of the acute angle α formed between (i) a plane or line 1111 that is tangent to the curved surface 1110 at said given point and (ii) a horizontal plane.

All mentions of a horizontal plane herein refer to a plane horizontal to a floor, and tangent planes or angles refer to planes or angles when the optical substrate is at rest on a horizontal surface.

In a first example, an optical substrate 1100 such as a lens blank has a front surface characterized by a base curve of 6.00 diopter. The lens blank has a diameter of 60 mm and a SAG number of 5.25 mm. A virtual tangent line 1111 (or plane) drawn at a point on the edge of the curved surface 1110 forms an angle α of 19.9° relative to the horizontal plane. The divergence of the area of the curved surface 1110 from that of the two-dimensional projection 1800 is such that at the point on the perimeter 1151 of the curved surface 1110, the area of the curved surface 1110 is 6.3% larger than at the corresponding point on the two-dimensional projection 1800. The area of outer annulus 1150 characterized by lying between 90% and 100% of a distance from the centroid of the curved surface 1110 and the perimeter 1151 is proportionally 5.6% to 5.7% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

In a second example, an optical substrate 1100 such as a lens blank has a front surface characterized by a base curve of 4.00 diopter. The lens blank has a diameter of 80 mm and a SAG number of 6.2 mm. A virtual tangent line 1111 (or plane) drawn at a point on the edge of the curved surface 1110 forms an angle α of 17.6° relative to the horizontal plane. The divergence of the area of the curved surface 1110 from that of the two-dimensional projection 1800 is such that at the point on the perimeter 1151 of the curved surface 1110, the area of the curved surface 1110 is 4.9% larger than at the corresponding point on the two-dimensional projection 1800. The area of outer annulus 1150 characterized by lying between 90% and 100% of a distance from the centroid of the curved surface 1110 and the perimeter 1151 is proportionally 4.4% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

In a third example, an optical substrate 1100 such as a lens blank has a front surface characterized by a base curve of 10.00 diopter. The lens blank has a diameter of 70 mm and a SAG number of 13.2 mm. A virtual tangent line 1111 (or plane) drawn at a point on the edge of the curved surface 1110 forms an angle α of 41.3° relative to the horizontal plane. The divergence of the area of the curved surface 1110 from that of the two-dimensional projection 1800 is such that at the point on the perimeter 1151 of the curved surface 1110, the area of the curved surface 1110 is 33.2% larger than at the corresponding point on the two-dimensional projection 1800. The area of outer annulus 1150 characterized by lying between 90% and 100% of a distance from the centroid of the curved surface 1110 and the perimeter 1151 is proportionally 28.5 to 28.6% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

In a fourth example, an optical substrate 1100 such as a lens blank has a front surface characterized by a base curve of 6.00 diopter. The lens blank has a diameter of 80 mm and a SAG number of 9.6 mm. A virtual tangent line 1111 (or plane) drawn at a point on the edge of the curved surface 1110 forms an angle α of 26.9° relative to the horizontal plane. The divergence of the area of the curved surface 1110 from that of the two-dimensional projection 1800 is such that at the point on the perimeter 1151 of the curved surface 1110, the area of the curved surface 1110 is 12.2% larger than at the corresponding point on the two-dimensional projection 1800. The area of outer annulus 1150 characterized by lying between 90% and 100% of a distance from the centroid of the curved surface 1110 and the perimeter 1151 is proportionally 10.8% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

In a fifth example, an optical substrate 1100 such as a lens blank has a front surface characterized by a base curve of 8.00 diopter. The lens blank has a diameter of 80 mm and a SAG number of 13.4 mm. A virtual tangent line 1111 (or plane) drawn at a point on the edge of the curved surface 1110 forms an angle α of 37.1° relative to the horizontal plane. The divergence of the area of the curved surface 1110 from that of the two-dimensional projection 1800 is such that at the point on the perimeter 1151 of the curved surface 1110, the area of the curved surface 1110 is 25.4% larger than at the corresponding point on the two-dimensional projection 1800. The area of outer annulus 1150 characterized by lying between 90% and 100% of a distance from the centroid of the curved surface 1110 and the perimeter 1151 is proportionally 22.1 to 22.2% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

### EXAMPLES

Reference is now made to the following examples, which together with the above description, illustrate the invention in a non-limiting fashion.

### Materials

### Photochromic Dyes:

Reversacol Amazon Green (James Robinson Specialty Ingredients Ltd.): a photochromic dyestuff in powder form;
Reversacol Midnight Gray (James Robinson Specialty Ingredients Ltd.): a photochromic dyestuff in powder form;
Reversacol Leather Brown (James Robinson Specialty Ingredients Ltd.): a photochromic dyestuff in powder form;
Reversacol Corn Yellow (James Robinson Specialty Ingredients Ltd.): a photochromic dyestuff in powder form;
Reversacol Ocean Blue (James Robinson Specialty Ingredients Ltd.): a photochromic dyestuff in powder form.

### Thermoplastic Resins

Pearlcoat™ DIPP 119—Aromatic polycaprolactone copolyester-based thermoplastic polyurethane (TPU) (Lubrizol)
Pearlbond™ 360—Polyether based thermoplastic polyurethane (TPU) (Lubrizol)
SETALUX® 2127 XX-60—Thermoplastic acrylic resin having good adhesion to plastics (Allnex)
Laropal A-81—Thermoplastic aldehyde resin (BASF).

### Primers and Overcoats

### Acrylic Polymer Emulsions:

Joncryl®1532—waterborne acrylic emulsion offering excellent adhesion to a wide variety of substrates including plastics (BASF); Primer
Joncryl®1534—waterborne acrylic emulsion offering excellent adhesion to a wide variety of substrates including plastics (BASF); Primer
Joncryl®2110—waterborne acrylic emulsion primer, styrene acrylate copolymer (BASF); Primer
Joncryl®9530-A—waterborne acrylic emulsion self-crosslinking polymer designed for use in topcoats and primers; Overcoat
Joncryl®617-A—waterborne acrylic polymer emulsion film forming overprint varnish formulations (BASF); Overcoat
SETALUX®17-7202—acetoacetate functional acrylic resin combined with a ketimine resin (SETALUX® 10-1440) for primer; Overcoat
SETALUX®17-1246—a fast-dry thermoplastic acrylic resin solution providing an excellent balance of hardness, adhesion and film toughness together with clarity and transparency; Overcoat
   PU polymer emulsions:
ALBERDINGK® APU 10600 self-crosslinking acrylic, PES/PC-polyurethane hybrid dispersion (Alberdingk Boley); Overcoat
Bondthane™ UD-620—self-crosslinking polyurethane is ideally suited for hard, clear or pigmented coatings for rigid plastics (BPI); Overcoat
CrystalCoat® PR 670—water-based emulsion (SDC); Primer
Hi-Gard HP 1500—thermal cured coating for hard coatings (PPG); Primer®

### Resin Solvent Based Solutions:

Versamid®PUR 1010—Primer
Laroflex®HS-9000—Primer.
   Solvents: low evaporation rate/low vapor pressure
TPM (Tripropylene glycol methyl ether, CAS 25498-49-1)
PPH (Ph-O-CH2-CHMe-OH, CAS 770-35-4)
DBA (2-(2-Butoxyethoxy)ethyl acetate, CAS 124-17-4)
TPnB (Tripropylene glycol n-butyl ether, 55934-93-5°) DPnP (Pr—O—[CH2-CHMe-O]2-H, CAS 29911-27-1)
Augeo® (HO-CH2-Me2Acetal, CAS 100-79-8)
DPnP (Pr—O—[CH2-CHMe-O]2-H, CAS 29911-27-1)
Butyl Carbitol (CAS 112-34-5)

### Equipment

### Coating Equipment

Ink-Jet Printer: Dimatix Materials Printer DMP-2831 equipped with a 10 μL Dimatix Materials Cartridge (Fujifilm Dimatix™ Inc); Ricoh gen4I mh2620, driven by GIS PMB C8 and hib-rh-384 (Ink feeding System: MegnaJet LabJet)
Microvalve: electromagnetically actuated (Fritz Gyger AG); nozzle diameter—0.1 mm, pressure 0.5-2.0 bar
Spin coater: MUTECH μCoater (Mutech Microsystems SAS)
UV LED Curing System: FJ100 Gen 2, 395 nm, 12 W/cm² (Phoseon Technology)
Thermal Curing System: Venticell ECO Forced air oven (MMM)
Surface Activation: Corona Treatment Device Electrical Surface Treatment HF SpotTEC Single (Tantec).

### Testing Equipment

Spectrophotometer: Cary 4000 UV-Vis. double-beam spectrophotometer, ISO/EN 8980-3:2013 (Agilent)
Light Transmittance and Haze Measuring Meter: TH-100, ASTM D1003/D1044 (Hangzhou CHN Spec Technology Co., Ltd.)
Thickness measurements: ThetaMetrisis layer thickness analyzer.

### Example 1: Corona Surface Treatment Procedure

The head of the corona treatment device (Tantec) was set at 1 cm from the surface of the ophthalmic lens and then was activated for 10 seconds. The process was performed twice before various coating materials were applied on the ophthalmic lens.

### Example 2: Procedure for Primer Application Using Spin-Coating

The ophthalmic lens was attached to the vacuum chuck of the spin coating apparatus. The spinning of the ophthalmic lens was performed at a spinning speed of 3000 rpm, an acceleration of 1000 rpm/see, for 10 seconds.

### Example 3: Procedure for Application of Post-Hardcoat Layers Using Spin-Coating

The ophthalmic lens was attached to the vacuum chuck of the spin coating apparatus. The spinning of the ophthalmic device was performed at a spinning speed of 1500 rpm, an acceleration of 500 rpm/see, for 10 seconds.

### Example 4: Optimization of Ink-Jetting Parameters

In various ink application steps, ink-jetting may optionally be employed. A Ricoh print head was used, typically with pre-heating to 40° C. The drop characteristics were then optimized for each ink using a Jet Expert stroboscope (Image Expert) mounted on the printer (camera and light source synchronized with the jetting frequency). The waveform was optimized for each ink, jetted at a frequency of 0.5-3 kHz. The distance between the printhead and the substrate was 0.6-1.0 mm. The jetting resulted in a drop size of about 50 micrometers (on the test substrate). The resolution was set at 300 dots per inch (dpi).

### Example 5: Microvalving a Film-Forming Ink onto a Lens Substrate

An optical construction having at least one of various functionalities (hardcoats, primer, overcoat, photochromic coatings, thermochromic coatings, tinted hardcoats, post-hardcoat coatings, etc.) was prepared by microvalving a film-forming ink onto a lens substrate. The microvalve was mounted on a controllable X-Y-Z stage, with a PLC synchronizing between the actuation of the microvalve and the positioning of the lens. Both frequency and relative velocity between the stage and the microvalve were maintained at fixed values. The microvalving was performed according to any one of various pre-determined digital patterns.

### Example 6A: Drying

Drying of the primer, overcoat, and photochromic ink was typically performed at 60° C. for 30 minutes, unless otherwise indicated.

### Example 6B: Thermal Curing

Thermal curing of the hardcoat (inner and outer) or tinted hardcoat was typically performed at 120° C. for 3 hours.

### Example 6C: UV Curing

UV curing was performed for 10 seconds using the UV LED Curing System: FJ100 Gen 2, 395 nm, 12 W/cm² (Phoseon Technology).

### Example 7

29 grams of DBA (2-(2-Butoxyethoxy)ethyl acetate) solvent were mixed with 66.6 grams of propylene glycol methyl ether solvent in a 200 ml glass beaker equipped with a magnetic stirrer. After mixing the components for 5 minutes at room temperature, 0.2 grams of surfactant BYK®-333 were added to the solvent mixture while mixing. 2 grams of Reversacol Midnight Gray dye were then added, along with 2.2 grams of Pearlbond™ 360 as a binder, while mixing. Mixing was continued for another 20 minutes at 60° C. to produce the photochromic ink, which was subsequently filtered with a syringe filter (0.45 micrometer).

### Example 8

28 grams of TPM solvent were mixed with 67.8 grams of ethyl acetate solvent in a 200 ml glass beaker equipped with a magnetic stirrer. After mixing the components for 5 minutes at room temperature, 0.2 grams of surfactant BYK®-358 were added to the solvent mixture while mixing. 2 grams of Reversacol Leather Brown dye were then added, along with 2 grams of Laropal A-81 as a binder, while mixing. Mixing was continued for another 20 minutes at 60° C. to produce the photochromic ink, which was subsequently filtered with a syringe filter (0.45 micrometer).

### Example 9

29.4 grams of TPM solvent were mixed with 62.5 grams of methyl isobutyl ketone solvent in a 200 ml glass beaker equipped with a magnetic stirrer. After mixing the components for 5 minutes at room temperature, 0.2 grams of surfactant BYK®-358 were added to the solvent mixture while mixing. 2 grams of Reversacol Midnight Gray dye and 2 grams of Reversacol Amazon Green dye were then added, along with 3.8 grams of Laropal A-81 as a binder, while mixing. Mixing was continued for another 20 minutes at 60° C. to produce the photochromic ink, which was subsequently filtered with a syringe filter (0.45 micrometer).

### Example 10

28.6 grams of TPM solvent were mixed with 66.8 grams of methyl propyl ketone solvent in a 200 ml glass beaker equipped with a magnetic stirrer. After mixing the components for 5 minutes at room temperature, 0.2 grams of surfactant BYK®-358 were added to the solvent mixture while mixing, followed by 2 grams of Reversacol Midnight Gray dye, 1 gram of Emoltene™ 3GO plasticizer, and 1.4 grams of SETALUX® 2127 XX-60. Mixing was continued for another 20 minutes at 60° C. to produce the photochromic ink, which was subsequently filtered with a syringe filter (0.45 micrometer).

### Example 11

27.6 grams of TPM solvent were mixed with 66.8 grams of ethyl acetate solvent in a 200 ml glass beaker equipped with a magnetic stirrer. After mixing the components for 5 minutes at room temperature, 0.2 grams of surfactant BYK®-358 were added to the solvent mixture while mixing, followed by 2 grams of Reversacol Amazon Green dye, 2.4 grams Pearlbond™ 360, and 1 gram of Pevalen plasticizer. Mixing was continued for another 20 minutes at 60° C. to produce the photochromic ink, which was subsequently filtered with a syringe filter (0.45 micrometer).

### Example 12

44 grams of TPM solvent were mixed with 51.8 grams of ethyl acetate solvent in a 200 ml glass beaker equipped with a magnetic stirrer. 1 gram of Pearlcoat DIPP 119 was added and mixing ensued for 2 hours at 60° C. 0.2 grams of surfactant BYK®-358 were added, while mixing, followed by 2 grams of Reversacol Amazon Green dye along with 2 grams of Pearlbond™ 360. Mixing was continued for another 20 minutes at 60° C. to produce the photochromic ink, which was subsequently filtered with a syringe filter (0.45 micrometer).

### Example 13

28.5 grams of Augeo® (HO-CH2-Me2Acetal) solvent were mixed with 62.8 grams of isopropyl acetate solvent in a 200 ml glass beaker equipped with a magnetic stirrer. After mixing the components for 5 minutes, 0.2 grams of surfactant BYK®-358 were added to the solvent mixture while mixing. 2 grams of Reversacol Midnight Gray dye, 2 grams of Reversacol Amazon Green dye, 3.5 grams of Pearlcoat DIPP 119 was added and mixing ensued for 2 hours at 60° C. and 1 gram of Emoltene™ 3GO plasticizer were then added while mixing. Mixing was continued for another 20 minutes at 60° C. to produce the photochromic ink, which was subsequently filtered with a syringe filter (0.45 micrometer).

### Example 14

30 grams of TPM solvent were mixed with 65.8 grams of MEK solvent in a 200 ml glass beaker equipped with a magnetic stirrer. 2 grams of Laropal® A-81 were added and mixing ensued for 2 hours at 60° C. 0.2 grams of surfactant BYK®-358 were added to the mixture while mixing, followed by 2 grams of Reversacol Amazon Green dye. Mixing was continued for another 20 minutes at 60° C. to produce the photochromic ink, which was subsequently filtered with a syringe filter (0.45 micrometer).

### Example 15

29 grams of TPM solvent were mixed with 66.3 grams of n-propyl acetate solvent in a 200 ml glass beaker equipped with a magnetic stirrer. 2.5 grams of Pearlbond 360 were added and mixing ensued for 2 hours at 60° C. 0.2 grams of surfactant BYK®-358 were added to the mixture while mixing, followed by 2 grams of Reversacol Amazon Green dye. Mixing was continued for another 20 minutes at 60° C. to produce the photochromic ink, which was subsequently filtered with a syringe filter (0.45 micrometer).

### Example 16

28.2 grams of butyl carbitol solvent were mixed with 66.8 grams of n-propyl acetate solvent in a 200 ml glass beaker equipped with a magnetic stirrer. 2.8 grams of SETALUX® 2127 XX-60 were added and mixing ensued for 2 hours at 60° C. 0.2 grams of surfactant BYK®-358 were added to the mixture while mixing, followed by 2 grams of Reversacol Amazon Green dye. Mixing was continued for another 20 minutes at 60° C. to produce the photochromic ink, which was subsequently filtered with a syringe filter (0.45 micrometer).

### Example 17

30 grams of TPM solvent were mixed with 65.8 grams of isobutyl acetate solvent in a 200 ml glass beaker equipped with a magnetic stirrer. 2 grams of Laropal® A-81 dispersion were added and mixing ensued for 2 hours at 60° C. 0.2 grams of surfactant BYK®-358 were added to the mixture while mixing, followed by 2 grams of Reversacol Corn Yellow dye. Mixing was continued for another 20 minutes at 60° C. to produce the photochromic ink, which was subsequently filtered with a syringe filter (0.45 micrometer).

### Example 18

28.8 grams of TPM solvent were mixed with 66.8 grams of MEK solvent in a 200 ml glass beaker equipped with a magnetic stirrer. 2.2 grams of SETALUX® 2127 XX-60 were added and mixing ensued for 2 hours at 60° C. 0.2 grams of surfactant BYK®-358 were added to the mixture while mixing, followed by 2 grams of Reversacol Midnight Gray dye. Mixing was continued for another 20 minutes at 60° C. to produce the photochromic ink, which was subsequently filtered with a syringe filter (0.45 micrometer).

### Example 19

30 grams of TPM solvent were mixed with 65.3 grams of ethyl acetate solvent in a 200 ml glass beaker equipped with a magnetic stirrer. 2.2 grams of SETALUX® 2127 XX-60 were added and mixing ensued for 2 hours at 60° C. 0.2 grams of surfactant BYK®-358 were added to the mixture while mixing. 2.3 grams of Reversacol Amazon Green dye were then added while mixing. Mixing was continued for another 20 minutes at 60° C. to produce the photochromic ink, which was subsequently filtered with a syringe filter (0.45 micrometer).

### Example 20

32 grams of TPM solvent were mixed with 63.4 grams of isobutyl acetate solvent in a 200 ml glass beaker equipped with a magnetic stirrer. 2.4 grams of SETALUX® 2127 XX-60 were added and mixing ensued for 2 hours at 60° C. 0.2 grams of surfactant BYK®-358 were added to the mixture while mixing. 2 grams of Reversacol Amazon Green dye were then added while mixing. Mixing was continued for another 20 minutes at 60° C. to produce the photochromic ink, which was subsequently filtered with a syringe filter (0.45 micrometer).

### Example 21

29 grams of TPM solvent were mixed with 66.5 grams of methyl propyl ketone solvent in a 200 ml glass beaker equipped with a magnetic stirrer. 2.3 grams of Pearlbond 360 were added and mixing ensued for 2 hours at 60° C. 0.2 gram of surfactant BYK®-358 were added to the mixture while mixing. 2 grams of Reversacol Amazon Ocean Blue dye were then added while mixing. Mixing was continued for another 20 minutes at 60° C. to produce the photochromic ink, which was subsequently filtered with a syringe filter (0.45 micrometer).

### Example 22

30 grams of butyl carbitol solvent were mixed with 65.8 grams of MEK solvent in a 200 ml glass beaker equipped with a magnetic stirrer. 1.8 grams of SETALUX® 2127 XX-60 were added and mixed for 2 hours at 60° C. 0.2 grams of surfactant BYK®-358 were added to the mixture while mixing. 2.2 grams of Reversacol Amazon Ocean Blue dye were then added while mixing. Mixing was continued for another 20 minutes at 60° C. to produce the photochromic ink, which was subsequently filtered with a syringe filter (0.45 micrometer).

### Example 23

30 grams of butyl carbitol solvent were mixed with 67.9 grams of MEK solvent in a 200 ml glass beaker equipped with a magnetic stirrer. After mixing the components for 5 minutes, 0.1 grams of surfactant BYK®-346 were added to the solvent mixture while mixing 1 gram of Reversacol Midnight Gray dye and 1 gram of Reversacol Amazon Green dye were added while mixing. Mixing was continued for another 20 minutes at 60° C. to produce the photochromic ink, which was subsequently filtered with a syringe filter (0.45 micrometer).

### Example 24

65 grams of Joncryl®1532 were mixed with 20 grams of water in a 200 ml glass beaker equipped with a magnetic stirrer. Then 9.5 grams of EB solvent, 4.8 grams of DPM solvent and 0.2 grams of BYK®024 were added while mixing. After mixing the components for 5 minutes, 0.5 grams of surfactant BYK®-346 were added to the mixture and the mixing was continued for another 10 minutes at 30° C., to produce a primer formulation.

### Example 25

70 grams of Joncryl®1534 were mixed with 15 grams of water in a 200 ml glass beaker equipped with a magnetic stirrer. Then 9.5 grams of EB solvent, 4.8 grams of DPM solvent and 0.2 grams of BYK®024 were added while mixing. After mixing the components for 5 minutes, 0.5 grams of surfactant EFKA®3200 were added to the mixture and the mixing was continued for another 10 minutes at 30° C., to produce a primer formulation.

### Example 26

75 grams of Joncryl®2110 were mixed with 10 grams of water in a 200 ml glass beaker equipped with a magnetic stirrer. Then 10 grams of EB solvent, 4.5 grams of DPM solvent and 0.25 grams of BYK®044 were added while mixing. After mixing the components for 5 minutes, 0.25 grams of surfactant BYK®346 were added to the mixture and the mixing was continued for another 10 minutes at 30° C., to produce a primer formulation.

### Example 27

The corona surface treatment procedure was performed on a Trivex® (PPG) lens made of urethane-based pre-polymer, according to Example 1.

### Example 28

The corona surface treatment procedure was performed on a polycarbonate lens according to Example 1.

### Example 29

The corona surface treatment procedure of Example 1 was performed on a polycarbonate lens that was pre-coated with a hardcoat.

### Example 30

The corona surface treatment procedure of Example 1 was performed on a Trivex® (PPG) lens that was pre-coated with a hardcoat.

### Example 31

The corona surface treatment procedure of Example 1 was performed on a CR-39® (PPG) lens made of poly(allyl diglycol carbonate) (PADC) that was pre-coated with a hardcoat.

### Example 32

Onto a polycarbonate lens was applied Versamid®PUR 1010 as a primer. Microvalving was effected according to Example 5, and a calculated (average) wet thickness of 1.8 μm was obtained. The wet layer was then subjected to thermal drying and curing in a Venticell ECO forced air oven at 60° C. for 10 minutes and then at 100° C. for 10 minutes, to produce the primer layer.

### Example 33

Onto a polycarbonate lens was applied Laroflex®HS-9000 as a primer. Microvalving was effected according to Example 5, and a calculated wet thickness of 2.1 μm was obtained. The wet layer was then subjected to thermal drying and curing in a Venticell ECO forced air oven at 60° C. for 10 minutes and then at 100° C. for 10 minutes, to produce a primer layer having a thickness of about 1.5 μm.

### Example 34

Onto a polycarbonate lens was applied the Joncryl®1534 formulation of Example 25 as a primer. Microvalving was effected according to Example 5, and a calculated wet thickness of 0.9 μm was obtained. The wet layer was then subjected to thermal drying and curing in a Venticell ECO forced air oven at 60° C. for 10 minutes and then at 100° C. for 10 minutes.

### Example 35

Onto the polycarbonate lens that had been corona-treated according to Example 29 was applied the Joncryl®1534 formulation of Example 25 as a primer. Microvalving was effected according to Example 5. The wet layer was then subjected to thermal drying and curing in a Venticell ECO forced air oven at 60° C. for 10 minutes and then at 100° C. for 10 minutes.

### Example 36

Onto the CR-39® lens that had been corona-treated according to Example 31 was applied the Joncryl®1534 formulation of Example 38 as a primer. Microvalving was effected according to Example 5. The wet layer was then subjected to thermal drying and curing in a Venticell ECO forced air oven at 60° C. for 10 minutes and then at 100° C. for 10 minutes.

### Examples 37-42: Microvalving a Photochromic Ink onto the Lens Surface

Photochromic dye formulations of Examples 14, 15, 17, 20, 21 and 23, which contain photochromic dye and a polymeric binder, were microvalved onto various lens substrates according to Example 5, at a pressure maintained below 1 bar.

### Example 43

Onto the coated polycarbonate lens produced in Example 39 was microvalved SETALUX® 17-7202 as an overcoat formulation. The wet layer, having a calculated average thickness of 13 μm, was then subjected to thermal drying in a Venticell ECO forced air oven at 60° C. for 30 minutes. The dry (average calculated) thickness was about 6.5 μm.

### Examples 44-48: Hardcoat Varnish Formulation

### Example 44: Non-Tinted Hardcoat Varnish

15.0 grams of 3-glycidoxypropyltrimethoxysilane, 33.6 grams of tetraethyl orthosilicate, 22.5 grams of itaconic acid and 24.8 grams of ethyl acetate were combined while being stirred for 10 minutes until a homogeneous mixture was achieved. 24.8 grams of water were added dropwise on top of the premixed silane solution by a peristaltic pump to make the resulting mixture. The mixture was then stirred for 12 hours to produce a coating composition.

### Example 45: Non-Tinted HC Varnish+Catalyst

0.2 grams of benzyldimethylamine was added dropwise to 99.8 grams of the mixture from Example 44 and mixed for 10 hours.

### Example 46: Non-Tinted HC Varnish+Nanoparticles

15.5 grams of 3-glycidoxypropyltrimethoxysilane, 25.5 grams of tetraethyl orthosilicate, 2.3 grams of itaconic acid and 23.2 grams of ethyl acetate were combined while being stirred for 20 minutes until a homogeneous mixture was achieved. 19.1 grams of water were added to 16.3 grams of Ludox HS-30 (Grace) nanosilica colloidal dispersion and mixed for 15 minutes and then it was added dropwise on top of the premixed silane solution by a peristaltic pump to make the resulting mixture. The mixture was then stirred for 24 hours to produce a coating composition.

### Example 47: Non-Tinted HC Varnish+Silane Additive

12.0 gram of methyltrimethoxysilane (Gelest), 8.0 grams of 3-glycidoxypropyltrimethoxysilane (Gelest), 29.1 grams of tetraethyl orthosilicate (Merck), 22.5 grams of succinic anhydride (Merck) and 24.8 grams of isopropyl acetate (Dow) were combined while being stirred for 10 minutes until a homogeneous mixture was achieved. 24.8 grams of water were added dropwise on top of the premixed silane solution by a peristaltic pump to make the resulting mixture. The mixture was then stirred for 7 hours to produce a coating composition.

### Example 48: Non-Tinted HC Varnish+Catalyst

1.5 gram of 10% w/w of potassium hydroxide water solution was added dropwise to 98.5 grams of the mixture from Example 47 and mixed for 15 hours.

### Examples 49A-49N: Hardcoat Formulations for Microvalving

Hardcoat formulations suitable for microvalving were formulated according to the Table provided below.

| Examples | HC Varnish/gr | | Solvent/gr | | Supplier | Wetting Agent | | Levelling Agent | |
|---|---|---|---|---|---|---|---|---|---|
| 49A | Example 44 | 87.6 | 2-(2-Butoxyethoxy)ethyl | 12.1 | Dow | BYK307 | 0.3 | | 0 |
| | | | acetate (DBA) | | | (Altana) | | | |
| 49B | Example 44 | 85.2 | 2-(2-Butoxyethoxy)ethyl | 14.4 | DOW | BYK333 | 0.2 | EFKA FL 3740 | 0.2 |
| | | | acetate | | | (Altana) | | EH (BASF) | |
| 49C | Example 44 | 89.65 | 2-(2-Butoxyethoxy)ethyl | 10 | DOW | BYK346 | 0.15 | BYK358 | 0.2 |
| | | | acetate (DBA) | | | | | (Altana) | |
| 49D | Example 45 | 91.1 | Propylene glycol phenyl | 8.5 | DOW | BYK307 | 0.3 | EFKA ® FL 3740 | 0.1 |
| | | | ether (PPh) | | | (BASF) | | EH (BASF) | |
| 49E | Example 45 | 93.0 | Propylene glycol phenyl | 6.4 | DOW | BYK306 | 0.4 | EFKA ® FL 3360 | 0.2 |
| | | | ether (PPh) | | | (BASF) | | | |
| 49F | Example 45 | 86.0 | Tripropylene glycol | 13.4 | DOW | BYK306 | 0.4 | EFKA ® FL 3360 | 0.2 |
| | | | monomethyl ether (TPM) | | | | | | |
| 49G | Example 46 | 91.4 | Propylene glycol phenyl | 8.2 | DOW | BYK307 | 0.3 | EFKA ® FL 3740 | 0.1 |
| | | | ether (PPh) | | | (BASF) | | EH (BASF) | |
| 49H | Example 47 | 91.4 | 2-(2-Butoxyethoxy)ethyl | 13.0 | DOW | BYK307 | 0.3 | EFKA ® FL 3740 | 0.1 |
| | | | acetate | | | (BASF) | | EH (BASF) | |
| 49I | Example 47 | 90.1 | 2-(2-Butoxyethoxy)ethyl | 9.3 | DOW | BYK306 | 0.4 | EFKA ® FL 3360 | 0.2 |
| | | | acetate | | | | | | |
| 49J | Example 48 | 92.1 | Propylene glycol phenyl | 7.4 | DOW | BYK306 | 0.4 | EFKA ® FL 3360 | 0.2 |
| | | | ether (PPh) | | | | | | |
| 49K | Example 48 | 89.1 | Tripropylene glycol | 10.3 | DOW | BYK306 | 0.4 | EFKA ® FL 3740 | 0.2 |
| | | | monomethyl ether (TPM) | | | | | EH (BASF) | |
| 49L | Example 44 | 89.46 | 2-(2-Butoxyethoxy)ethyl | 10.3 | DOW | BYK333 | 0.15 | BYK358 | 0.1 |
| | | | acetate (DBA) | | | (BASF) | | (Altana) | |
| 7M | Example 46 | 91.4 | Propylene glycol phenyl | 8.2 | DOW | BYK307 | 0.3 | EFKA ® FL 3740 | 0.1 |
| | | | ether (PPh) | | | (BASF) | | EH (BASF) | |
| 7N | Example 47 | 89.1 | Tripropylene glycol | 10.3 | | BYK306 | 0.4 | EFKA ® FL | 0.2 |
| | | | monomethyl ether (TPM) | | | | | B3360 | |

### Examples 50A-50N: Hardcoat Formulations for Microvalving

Tinted hardcoat formulations suitable for microvalving were formulated according to the Table provided below:

| Examples | HC Varnish/gr | | Solvent/gr | | Supplier | Dye/gr | | Wetting Agent | | Levelling Agent | |
|---|---|---|---|---|---|---|---|---|---|---|---|
| 50A | Example 44 | 85.4 | 2-(2- | 12.1 | Dow | Solvent Blue 70 | 2.2 | BYK307 | 0.3 | | 0 |
| | | | Butoxyethoxy)ethyl | | | | | (Altana) | | | |
| | | | acetate (DBA) | | | | | | | | |
| 50B | Example 44 | 83.6 | 2-(2- | 14.4 | DOW | Magenta S2 | 1.6 | BYK333 | 0.2 | EFKA FL | 0.2 |
| | | | Butoxyethoxy)ethyl | | | | | (Altana) | | 3740 EH | |
| | | | acetate | | | | | | | (BASF) | |
| 50C | Example 44 | 86.45 | 2-(2- | 10 | DOW | Solvent Yellow 82 | 3.2 | BYK346 | 0.15 | BYK358 | 0.2 |
| | | | Butoxyethoxy)ethyl | | | | | | | (Altana) | |
| | | | acetate (DBA) | | | | | | | | |
| 50D | Example 45 | 89 | Propylene glycol | 8.5 | DOW | Solvent Black 27 | 2.1 | BYK307 | 0.3 | EFKA ® FL | 0.1 |
| | | | phenyl ether (PPh) | | | | | (BASF) | | 3740 EH | |
| | | | | | | | | | | (BASF) | |
| 50E | Example 45 | 91.2 | Propylene glycol | 6.4 | DOW | Solvent Blue 70 | 1.8 | BYK306 | 0.4 | EFKA ® FL | 0.2 |
| | | | phenyl ether (PPh) | | | | | (BASF) | | 3360 | |
| 50F | Example 46 | 84.2 | Tripropylene glycol | 13.4 | DOW | Solvent Blue 70 | 1.8 | BYK306 | 0.4 | EFKA ® FL | 0.2 |
| | | | monomethyl ether | | | | | | | 3360 | |
| | | | (TPM) | | | | | | | | |
| 50G | Example 46 | 89 | Propylene glycol | 8.2 | DOW | Solvent Blue 70 | 2.4 | BYK307 | 0.3 | EFKA ® FL | 0.1 |
| | | | phenyl ether (PPh) | | | | | (BASF) | | 3740 EH | |
| | | | | | | | | | | (BASF) | |
| 50H | Example 47 | 89 | 2-(2- | 13.0 | DOW | Solvent Yellow 82 | 2.4 | BYK307 | 0.3 | EFKA ® FL | 0.1 |
| | | | Butoxyethoxy)ethyl | | | | | (BASF) | | 3740 EH | |
| | | | acetate | | | | | | | (BASF) | |
| 50I | Example 47 | 87 | 2-(2- | 9.3 | DOW | Magenta S2 | 3.1 | BYK306 | 0.4 | EFKA ® FL | 0.2 |
| | | | Butoxyethoxy)ethyl | | | | | | | 3360 | |
| | | | acetate | | | | | | | | |
| 50J | Example 48 | 89.9 | Propylene glycol | 7.4 | DOW | Solvent Blue 70 | 2.1 | BYK306 | 0.4 | EFKA ® FL | 0.2 |
| | | | phenyl ether (PPh) | | | | | | | 3360 | |
| 50K | Example 48 | 87.5 | Tripropylene glycol | 10.3 | DOW | Solvent Black 27 | 1.6 | BYK306 | 0.4 | EFKA ® FL | 0.2 |
| | | | monomethyl ether | | | | | | | 3740 EH | |
| | | | (TPM) | | | | | | | (BASF) | |
| 50L | Example 44 | 87.63 | 2-(2- | 10.3 | DOW | Solvent Blue 70 | 0.5 | BYK333 | 0.15 | BYK358 | 0.1 |
| | | | Butoxyethoxy)ethyl | | | Solvent Yellow 82 | 0.25 | (BASF) | | (Altana) | |
| | | | acetate (DBA) | | | Solvent Black 27 | 0.7 | | | | |
| | | | | | | Magenta S2 | 0.375 | | | | |
| 50M | Example 46 | 89.575 | Propylene glycol | 8.2 | DOW | Solvent Blue 70 | 0.5 | BYK307 | 0.3 | EFKA ® FL | 0.1 |
| | | | phenyl ether (PPh) | | | Yellow 82 | 0.25 | (BASF) | | 3740 EH | |
| | | | | | | Solvent Black 27 | 0.7 | | | (BASF) | |
| | | | | | | Magenta S2 | 0.375 | | | | |
| 50N | Example 47 | 87.3 | Tripropylene glycol | 10.3 | | Solvent Blue 70 | 0.6 | BYK306 | 0.4 | EFKA ® FL | 0.2 |
| | | | monomethyl ether | | | Yellow 82 | 0.4 | | | 3360 | |
| | | | (TPM) | | | Solvent Black 27 | 0.8 | | | | |

### Example 51

Onto the coated polycarbonate lens produced in Example 39 was microvalved the formulations of Examples 49A-49N as hardcoats.

### Example 52

Onto the coated polycarbonate lens produced in Example 39 was microvalved the formulations of Examples 50A-50N as tinted hardcoats.

### Example 53: Measuring Haze & % Transmittance

After calibrating the T-100 instrument, the Target lens was measured (uncoated reference lens). In Sample mode, the coated lens was then tested. The instrument then displayed the following results of the coated and uncoated lenses: % Transmittance, Δ % Transmittance, Haze, and A Haze. Lower delta values between the coated and uncoated lens indicate good optical clarity/transparency.

### Example 54: Measuring Tinting Properties

Spectrophotometric studies were conducted using a Cary 4000 UV-Vis. double-beam spectrophotometer. The light source was a UV-LED lamp (395 nm). In the spectrophotometric studies, the coated samples were characterized against an uncoated reference slide or lens. Spectrum data were normally collected in the range 350-700 nm at a resolution of 1 nm. Transmittance measurements were performed at the wavelength of maximal absorbance for each tinting dye.

As used herein in the specification and in the claims section that follows, the term “percent”, or “%”, refers to percent by weight, unless specifically indicated otherwise.

As used herein in the specification and in the claims section that follows, the terms “anti-glare”, “anti-reflectance”; “anti-fog”; “hardcoat”; “ultraviolet absorber”; “photochromic”, “tinting” “blue-light absorber”, and the like, unless otherwise specified, are meant as used in the art of optical substrate coatings.

As used herein in the specification and in the claims section that follows, the term “anti-scratch”, with respect to a material such as a formulation or a coating, refers to a material whose dried and cured coating exhibits a haze value of less than 6%, using the following taber abrasion properties, according to ASTM D1004-08: CS 10 F wheel, 500 g Load, 500 cycles.

Alternatively, the term “anti-scratch”, with respect to a material such as a formulation or a coating, refers to a material whose Bayer number is at least 5 or at least 6 when using ASTM F735-21.

The term “ratio”, as used herein in the specification and in the claims section that follows, refers to a weight ratio, unless specifically indicated otherwise.

As used herein in the specification and in the claims section that follows, the term “SAGITTA”, or “SAG”, with reference refers to the convex curvature of an optical substrate, represents the physical distance between the vertex (the highest point of the convex curvature) along the curved surface of the optical substrate and the center point of a line drawn perpendicular to the curved surface from one edge of the optical substrate to the other. The SAG may be measured, or determined according to the following established equation:

$$SAG = \vert R \vert - \sqrt{{R}^{2} - {( \frac{D}{2} )}^{2}}$$

wherein R is the radius of curvature of the optical surface and D is the diameter thereof.

As used herein in the specification and in the claims section that follows, the term “non-volatile component”, with respect to a formulation or formulation on a lens/optical substrate, relates to the residue left after driving off some or all of the solvents and carrier liquids from the lens/optical surface after subjecting the lens/optical substrate, coated with the formulation, to oven-drying at 120° C. for 3 hours. The residue includes the solid particles within the formulation, along with dissolved solids that remain after the solvent has been removed.

The “thickness” of a layer or a plurality of layers at a particular location is measured in the direction that is normal (N) to the lens substrate at that location.

Various types of thin-film thickness measurements are know to those of skill in the art. For example, single-spot thickness measurements may be performed by spectral reflectance or by spectroscopic ellipsometry.

In addition, mapping of thin-film surfaces and calculation of average thicknesses of such films may be performed using these techniques.

The “average thickness” of a wet layer may be determined as follows: when a volume of material vol covers a surface area of a surface having an area SA with a wet layer—the thickness of the wet layer is assumed to be vol/SA. If the weight of the materials is known, vol may be calculated by dividing by the material's specific gravity. Typically, the specific gravity of the various coating materials may safely be approximated as 1.00.

The “average thickness” of a dried film may be calculated as follows: when a volume of material vol that is x % liquid, by weight, wets or covers a surface area SA of a surface, and all the liquid is evaporated away to convert the wet layer into a dry film, the thickness of the dry film is calculated as:

$$vol / {ρ}_{wet layer} ( 100 - x ) / ( SA \cdot {ρ}_{dry layer} )$$

where ρ_{wet layer} is the specific gravity of the wet layer and ρ_{dry layer} is the specific gravity of the dry layer. This calculation requires a knowledge of various properties of the wet coating material of the film, e.g., the specific gravity. As mentioned above, typically, the specific gravities may be assumed to be 1.

Similarly, an average diameter of drops such as jetted or microvalved drops (Ddrop) may be calculated by weighing a large number of the jetted drops, converting the total weight into volume using the specific gravity, dividing by the number of drops, and utilizing the equation relating spherical drop diameter to sphere volume: D=(6*V/π)^{1/3}.

It will be appreciated by those of skill in the art that the various layers disposed on the optical or ophthalmic surface (e.g., the lens surface) of the present invention are generally of a substantially even thickness, hence, the “average thickness” may be determined by evaluating one or more spot thicknesses on the film or layer.

As used herein in the specification and in the claims section that follows, the term “characteristic”, with respect to an ink dot dimension such as height, length or diameter, refers to the maximal value of that dot dimension. By way of example, for a square dot, 30 micrometers on a side, the characteristic diameter would be the diagonal, i.e., 30√2=42.4 micrometers. For a dot having some peaks on the top surface, distal to the optical substrate, the dot height would be the maximum height measured normal to the top surface of the substrate. For a plurality of dots, the characteristic dimension is the average of the characteristic dimension of the individual dots within the plurality.

As used herein in the specification and in the claims section that follows, the term “average”, with respect to a dimension of a plurality of dots such as the height, length or diameter thereof, refers to the arithmetic mean of that dimension, and is calculated using the characteristic dimension for each dot in the plurality.

As used herein in the specification and in the claims section that follows, the term “transparent”, typically with respect to a material, e.g., a material used in a coating, or as a substrate, may be determined according to ASTM D1003. Utilizing ASTM D1003, a material having a haze measurement of less than 2% and a total transmittance (Tₜ) of at least 85% is considered “transparent”. More typically, the haze is at most 1.5% or at most 1.0%. More typically, Tₜ is at least 90% or at least 95%. Yet more typically, the haze is at most 1.0% and Tₜ is at least 95%.

As used herein in the specification and in the claims section that follows, the term “liquid medium” and the like refers to a medium that is liquid at its temperature of use. For example, the liquid medium in an ink-jet ink jetted at 38° C. is a liquid at 38° C. A “liquid medium” is typically liquid at 25° C.

In the context of the present application and claims, the phrase “at least one of A and B” is equivalent to an inclusive “or”, and includes any one of “only A”, “only B”, or “A and B”. Similarly, the phrase “at least one of A, B, and C” is equivalent to an inclusive “or”, and includes any one of “only A”, “only B”, “only C”, “A and B”, “A and C”, “B and C”, or “A and B and C”.

As used herein in the specification and in the claims section that follows, the terms “top”, “bottom”, “above”, “below”, “upper”, “lower”, “height” and “side” and the like are utilized for convenience of description or for relative orientation, and are not necessarily intended to indicate an absolute orientation in space.

### Additional Embodiments

Various formulations, methods, optical constructions, and systems are disclosed herein. Additional Embodiments are provided hereinbelow.

### Method Embodiments

1. A method of producing an optical construction on an optical substrate, the method comprising:
   (a) microvalving drops of a liquid film-forming formulation onto an optical surface of the optical substrate, to form a wet layer;
   (b) treating the wet layer to produce a dried transparent layer on said optical surface; wherein optionally, said optical surface is a curved surface, and wherein optionally, said optical surface is a polymeric surface.
2. The method of claim 1, wherein said optical surface has said curved surface.
3. The method of claim 1 or claim 2, wherein said optical surface has said polymeric surface.
4. A method of producing an optical construction on an optical substrate, the method comprising:
   (a) microvalving drops of a liquid film-forming formulation onto an optical surface of the optical substrate, to form a wet layer;
   (b) treating the wet layer to produce a dried transparent layer on said optical surface; wherein said optical surface is a curved surface, and wherein optionally, said optical surface is a polymeric surface.
5. The method of claim 4, wherein said optical surface has said polymeric surface.
6. The method of any one of the preceding claims, wherein said liquid film-forming formulation is a hardcoat formulation.
6A. The method of any one of the preceding claims, wherein said liquid film-forming formulation is an overcoat formulation.
7. A method of producing an optical construction on an optical substrate, the method comprising:
   (a) microvalving drops of a liquid film-forming formulation onto an optical surface of the optical substrate, to form a wet layer;
   (b) treating the wet layer to produce a dried transparent layer on said optical surface; wherein said liquid film-forming formulation is a hardcoat formulation; and wherein optionally, said optical surface is a curved surface.
8. The method of claim 7, said optical surface having said curved surface.
9. The method of any one of the preceding claims, wherein a non-volatile component of said liquid film-forming formulation makes up at least 10%, on a weight basis.
10. The method of claim 9, wherein said non-volatile component of said liquid film-forming formulation makes up at least 15%.
11. The method of claim 9, wherein said non-volatile component makes up at least 20%.
12. The method of claim 9, wherein said non-volatile component makes up at least 25%.
13. The method of claim 9, wherein said non-volatile component makes up at least 30%.
14. The method of claim 9, wherein said non-volatile component makes up at least 35%.
15. The method of claim 9, wherein said non-volatile component makes up at least 40%.
16. The method of claim 9, wherein said non-volatile component makes up at least 45%.
17. The method of claim 9, wherein said non-volatile component makes up at least 50%.
18. The method of any one of claims 9 to 17, wherein said non-volatile component makes up at most 75%.
19. The method of claim 18, wherein said non-volatile component makes up at most 70%.
20. The method of claim 18, wherein said non-volatile component makes up at most 65%.
21. The method of claim 18, wherein said non-volatile component makes up at most 60%.
22. The method of claim 18, wherein said non-volatile component makes up at most 55%.
23. The method of any one of the preceding claims, wherein the SAG number of said optical substrate is at least 0.5 mm.
24. The method of claim 23, wherein the SAG number of said optical substrate is at least 1 mm.
25. The method of claim 23, wherein the SAG number of said optical substrate is at least 2 mm.
26. The method of claim 23, wherein the SAG number of said optical substrate is at least 3.5 mm.
27. The method of claim 23, wherein the SAG number of said optical substrate is at least 5 mm.
28. The method of claim 23, wherein the SAG number of said optical substrate is at most 12 mm.
29. The method of any one of claims 1 to 28, wherein a total solvent content of said liquid film-forming formulation, in weight-%, is St, and wherein said liquid film-forming hardcoat formulation contains a high vapor-pressure solvent Hvp and a low vapor-pressure solvent Lvp.
30. The method of claim 29, wherein the concentration of Lvp is at least 2% of St.
31. The method of claim 30, wherein the concentration of Lvp is at least 5% of St.
32. The method of claim 30, wherein the concentration of Lvp is at least 10% of St.
33. The method of claim 30, wherein the concentration of Lvp is at least 15% of St.
34. The method of claim 30, wherein the concentration of Lvp is at least 20% of St.
35. The method of claim 30, wherein the concentration of Lvp is at least 25% of St.
36. The method of claim 30, wherein the concentration of Lvp is at least 30% of St.
37. The method of claim 30, wherein the concentration of Lvp is at least 35% of St.
38. The method of claim 30, wherein the concentration of Lvp is at least 40% of St.
39. The method of claim 30, wherein the concentration of Lvp is at least 45% of St.
40. The method of claim 30, wherein the concentration of Lvp is at least 50% of St.
41. The method of claim 30, wherein the concentration of Lvp is at least 55% of St.
42. The method of any one of claims 29 to 41, wherein the concentration of Lvp is at most 80% of St.
43. The method of claim 42, wherein the concentration of Lvp is at most 75% of St.
44. The method of claim 42, wherein the concentration of Lvp is at most 70% of St.
45. The method of claim 42, wherein the concentration of Lvp is at most 65% of St.
46. The method of claim 42, wherein the concentration of Lvp is at most 60% of St.
47. The method of any one of claims 30 to 40, wherein the concentration of Lvp is at most 55% of St.
48. The method of any one of claims 30 to 39, wherein the concentration of Lvp is at most 50% of St.
49. The method of any one of claims 30 to 38, wherein the concentration of Lvp is at most 45% of St.
50. The method of any one of claims 30 to 37, wherein the concentration of Lvp is at most 40% of St.
51. The method of any one of claims 30 to 36, wherein the concentration of Lvp is at most 35% of St.
52. The method of any one of claims 29 to 31, wherein the concentration of Hvp is at most 90% of St.
53. The method of any one of claims 29 to 32, wherein the concentration of Hvp is at most 85% of St.
54. The method of any one of claims 29 to 33, wherein the concentration of Hvp is at most 80% of St.
55. The method of any one of claims 29 to 34, wherein the concentration of Hvp is at most 70% of St.
56. The method of any one of claims 29 to 37, wherein the concentration of Hvp is at most 60% of St.
57. The method of any one of claims 29 to 39, wherein the concentration of Hvp is at most 50% of St.
58. The method of any one of claims 29 to 40, wherein the concentration of Hvp is at most 40% of St.
59. The method of any one of claims 29 to 41, wherein the concentration of Hvp is at most 30% of St.
60. The method of any one of claims 29 to 59, wherein, on an n-butyl acetate normalized 25° C. evaporation rate scale, Lvp has a normalized evaporation rate of at most 0.4.
61. The method of claim 60, wherein said normalized evaporation rate of Lvp is at most 0.3.
62. The method of claim 60, wherein said normalized evaporation rate of Lvp is at most 0.2.
63. The method of claim 60, wherein said normalized evaporation rate of Lvp is at most 0.1.
64. The method of claim 60, wherein said normalized evaporation rate of Lvp is at most 0.05.
65. The method of claim 60, wherein said normalized evaporation rate of Lvp is at most 0.02.
66. The method of any one of claims 60 to 65, wherein said normalized evaporation rate of Lvp is at least 0.001.
67. The method of claim 66, wherein said normalized evaporation rate of Lvp is at least 0.002.
68. The method of claim 66, wherein said normalized evaporation rate of Lvp is at least 0.004.
69. The method of claim 66, wherein said normalized evaporation rate of Lvp is at least 0.007.
70. The method of any one of claims 29 to 69, wherein, on an n-butyl acetate normalized 25° C. evaporation rate scale, Hvp has a normalized evaporation rate of at least 0.7.
71. The method of claim 70, wherein said normalized evaporation rate of Hvp is at least 0.8.
72. The method of claim 70, wherein said normalized evaporation rate of Hvp is at least 1.0.
73. The method of claim 70, wherein said normalized evaporation rate of Hvp is at least 1.2.
74. The method of claim 70, wherein said normalized evaporation rate of Hvp is at least 1.5.
75. The method of claim 70, wherein said normalized evaporation rate of Hvp is at least 2.0.
76. The method of claim 70, wherein said normalized evaporation rate of Hvp is at least 2.6.
77. The method of claim 70, wherein said normalized evaporation rate of Hvp is at least 3.2.
78. The method of claim 70, wherein said normalized evaporation rate of Hvp is at least 3.8.
79. The method of any one of claims 70 to 78, wherein said normalized evaporation rate of Hvp is at most 11.
80. The method of claim 79, wherein said normalized evaporation rate of Hvp is at most 9.5.
81. The method of claim 79, wherein said normalized evaporation rate of Hvp is at most 8.
82. The method of claim 79, wherein said normalized evaporation rate of Hvp is at most 7.
83. The method of claim 79, wherein said normalized evaporation rate of Hvp is at most 6.5.
84. The method of any one of the preceding claims, wherein said dried transparent layer is a dried hardcoat layer.
85. The method of any one of the preceding claims, wherein at least one of a thickness Twl and an average thickness Ta-wl of said wet layer is at most 90 micrometers (μm).
86. The method of claim 85, wherein at least one of Twl and Ta-wl is at most 70 μm.
87. The method of claim 85, wherein at least one of Twl and Ta-wl is at most 60 μm.
88. The method of claim 85, wherein at least one of Twl and Ta-wl is at most 50 μm.
89. The method of claim 85, wherein at least one of Twl and Ta-wl is at most 40 μm.
90. The method of claim 85, wherein at least one of Twl and Ta-wl is at most 30 μm.
91. The method of claim 85, wherein at least one of Twl and Ta-wl is at most 20 μm.
92. The method of claim 85, wherein at least one of Twl and Ta-wl is at most 15 μm.
93. The method of claim 85, wherein at least one of Twl and Ta-wl is at most 12 μm.
94. The method of claim 85, wherein at least one of Twl and Ta-wl is at most 10 μm.
95. The method of any one of claims 85 to 94, wherein a 25° C. viscosity of said liquid film-forming formulation is at most 55 cP.
96. The method of claim 95, wherein said 25° C. viscosity is at most 45 cP.
97. The method of claim 95, wherein said 25° C. viscosity is at most 35 cP.
98. The method of claim 95, wherein said 25° C. viscosity is at most 25 cP.
99. The method of claim 95, wherein said 25° C. viscosity is at most 20 cP.
100. The method of claim 95, wherein said 25° C. viscosity is at most 15 cP.
101. The method of claim 95, wherein said 25° C. viscosity is at most 12 cP.
102. The method of claim 95, wherein said 25° C. viscosity is at most 10 cP.
103. The method of claim 95, wherein said 25° C. viscosity is at most 8 cP.
104. The method of any one of claims 95 to 103, wherein said 25° C. viscosity of said liquid film-forming formulation is at least 1.5 cP.
105. The method of claim 104, wherein said 25° C. viscosity is at least 2.5 cP.
106. The method of claim 104, wherein said 25° C. viscosity is at least 4 cP.
107. The method of claim 104, wherein said 25° C. viscosity is at least 6 cP.
108. The method of any previous Embodiment, wherein the base curve of the optical substrate is at least 2.
109. The method of Embodiment 108, wherein the base curve is at least 3.
110. The method of Embodiment 108, wherein the base curve is at least 4.
111. The method of Embodiment 108, wherein the base curve is at least 5.
112. The method of Embodiment 108, wherein the base curve is at least 6.
113. The method of Embodiment 108, wherein the base curve is at least 8.
114. The method of any previous Embodiment, wherein the base curve of the optical substrate is at most 14.
115. The method of Embodiment 114, wherein the base curve is at most 12.
116. The method of Embodiment 114, wherein the base curve is at most 10.
117. The method of any previous Embodiment, wherein for any point on the target surface, a an acute angle formed between (i) a plane that is tangent to the target surface at said given point and (ii) a horizontal plane is an angle (α), and wherein the maximum α on the target surface is αₘₐₓ, and wherein is αₘₐₓ is at least 5°.
118. The method of Embodiment 117, wherein αₘₐₓ is at least 7°.
119. The method of Embodiment 117, wherein αₘₐₓ is at least 10°.
120. The method of Embodiment 117, wherein αₘₐₓ is at least 13°.
121 The method of Embodiment 117, wherein αₘₐₓ is at least 16°.
122. The method of Embodiment 117, wherein αₘₐₓ is at least 19°
123. The method of Embodiment 117, wherein αₘₐₓ is at least 23°.
124. The method of Embodiment 117, wherein αₘₐₓ is at least 26°.
125. The method of Embodiment 117, wherein αₘₐₓ is at least 31°, at least 34°, or at least 40°.
126. The method of any of Embodiments 117 to 125, wherein αₘₐₓ is at most 50°.
127. The method of Embodiment 126, wherein αₘₐₓ is at most 42°.
128. The method of Embodiment 126, wherein αₘₐₓ is at most 37°.

### Optical Construction Embodiments

1. An optical construction, as described herein.
2. An optical construction comprising any of the structural features disclosed in the above-provided method Embodiments.
3. An optical construction comprising any of the structural features disclosed in system Embodiments 1 to 70.
4. The optical construction of any of Embodiments 1 to 3, wherein the optical construction is or includes an eyeglass lens.
5. Eyeglasses comprising an eyeglass frame and at least one eyeglass lens of Embodiment 4.

### System Embodiments

1. A coating system comprising:
   (a) an ink-formulation-application station including microvalve apparatus configured to microvalve droplets of an ink-formulation onto a target surface of an optical substrate to form a wet layer on the target surface; and
   (b) a drying and/or curing station configured to dry and/or cure the wet ink layer to produce a cured coating on the target surface.
2. The system of Embodiment 1, further comprising:
   (c) an optical-substrate transfer apparatus configured to transfer the optical substrate having the wet layer on the target surface thereof from the ink-formulation-application station to the drying and/or curing station.
3. The system of Embodiment 1 or 2, wherein the optical-substrate-transfer apparatus includes at least one of a robotic arm, a gripper, a conveyer belt, and an elevator for raising or lowering an elevation of the optical substrate on the target surface thereof.
4. The system of any previous Embodiment, further comprising a controller programmed or programmable to regulate the optical-substrate-transfer apparatus such that the transfer of the optical substrate is contingent upon a detection that the wet ink layer has been formed on the target surface of the optical substrate at the ink-formulation-application station.
5. The system of any previous Embodiment, wherein the drying and/or curing station includes at least one of a heat lamp, an oven, and a UV-curing mechanism.
6. The system of any previous Embodiment, wherein the drying and/or curing station includes an oven which: (i) is open when the optical substrate having the wet ink layer on the target surface thereof is transferred thereinto, and (ii) is closed, subsequent to transfer of the optical substrate to the oven, and remains closed during the drying and/or curing.
7. The system of any previous Embodiment, further comprising a primer application station configured to apply droplets of a primer formulation onto the target surface before microvalving ink-formulation thereupon.
8. The system of Embodiment 7, wherein the primer application station includes a microvalve apparatus for applying drops of the primer formulation.
9. The system of any previous Embodiment, further comprising at least one of: (i) a treatment station for increasing the surface energy of the target surface before application thereon of the primer or the ink formulation; and (ii) a cleaning station for subjecting the target surface to a cleaning process before application thereon of the primer or the ink formulation.
10. The system of Embodiment 9, further comprising the surface energy treatment station, said surface energy station including at least one of a corona-treatment-apparatus and a plasma-treatment-apparatus.
11. The system of any preceding Embodiment, wherein the ink-formulation-application station includes a reservoir of the ink formulation and is configured to microvalve, onto the target surface of the optical substrate, ink formulation stored in the reservoir.
12. The system of any preceding Embodiment, wherein the system is further configured to apply, optionally by microvalving, at least one of a tint formulation and a photochromic formulation to the target surface of the optical substrate before the application thereon of the wet layer of the ink formulation.
13. The system of any preceding Embodiment, wherein the system is devoid of dip coating apparatus.
14. The system of any preceding Embodiment, wherein the system is devoid of spin coating apparatus.
15. The system of any preceding Embodiment, including a controller configured or programmed to control the microvalving of the droplets of the ink formulation onto the target surface.
16. The system of any one of the preceding Embodiments, wherein the target surface is curved.
17. The system of any one of the preceding Embodiments, wherein the target surface has a SAG number of at least 0.5 mm.
18. The system of any one of Embodiments 15 to 17, wherein the controller is configured or programmed to control the microvalving such that a ratio of a volume of formulation applied per unit of area of a two-dimensional projection of the target surface is constant.
19. The system of any one of Embodiments 15 to 17, wherein the controller is configured or programmed to control the microvalving such that a ratio of a volume of formulation applied per unit of area of a two-dimensional projection of the target surface, within any subdivision of said two-dimensional projection having an area of 5% or more of an area of the projection, is within ±10%, or within ±5%, or within ±2%, or within ±1% of a mean value of said ratio for all of said two-dimensional projection
20. The system of any one of Embodiments 15 to 19, wherein the controller is configured or programmed to generate the two-dimensional projection of the target surface, before the microvalving.
21. The system of any one of Embodiments 15 to 20, wherein the controller is configured or programmed to calculate or select a ratio of the volume of formulation per unit of area of the two-dimensional projection of the target surface, before the microvalving.
22. The system of Embodiment 21, wherein the controller is configured or programmed to control the microvalving such that a ratio of a volume of formulation applied per unit of area of a two-dimensional projection of the target surface, within any subdivision of said two-dimensional projection having an area of 5% or more of an area of the projection, is within ±10%, or within ±5%, or within ±2%, or within ±1% of said calculated or selected ratio.
23. The system of any preceding Embodiment, wherein the microvalving is such that a ratio of a mean volume of formulation applied per unit of area of the target surface in an edge portion thereof characterized by lying between 90% and 100% of a distance from a centroid of the target surface and a perimeter thereof, is between 0.60 and 0.96 times a maximum ratio of a volume of formulation applied per unit of area of the target surface.
24. The system of any of Embodiments 1 to 22, wherein the microvalving is such that a ratio of a mean volume of formulation applied per unit of area of the target surface in an edge portion thereof characterized by lying between 90% and 100% of a distance from a centroid of the target surface and a perimeter thereof, is between 0.60 and 0.96 times a mean ratio of a volume of formulation applied per unit of area in a central area characterized by lying between 0% and 10% of a distance from said centroid of the target surface and said perimeter.
25. The system of either one of Embodiments 23 or 24, wherein the SAG number of the target surface is at least 1 mm and at most 15 mm.
26. The system of Embodiment 25, wherein the SAG number is at least 2 mm.
27. The system of Embodiment 25, wherein the SAG number is at least 3.5 mm.
28. The system of Embodiment 25, wherein the SAG number is at least 4.5 mm.
29. The system of Embodiment 25, wherein the SAG number is at least 5 mm.
30. The system of Embodiment 25, wherein the SAG number is at least 6 mm.
31. The system of Embodiment 25, wherein the SAG number is at least 7 mm.
32. The system of Embodiment 25, wherein the SAG number is at least 9 mm.
33. The system of any of Embodiments 25 to 32, wherein the SAG number is at most 13.5 mm.
34. The system of Embodiment 33, wherein the SAG number is at most 12 mm.
35. The system of Embodiment 33, wherein the SAG number is at most 10.5 mm.
36. The system of any of Embodiments 25 to 31, wherein the SAG number is at most 8 mm.
37. The system of any one of Embodiments 23 to 36, wherein the ratio in the edge portion is between 0.6 and 0.9 times the maximum ratio.
38. The system of any one of Embodiments 23 to 36, wherein the ratio in the edge portion is between 0.6 and 0.85 times the maximum ratio.
39. The system of any one of Embodiments 23 to 36, wherein the ratio in the edge portion is between 0.8 and 0.96 times the ratio in the central area.
40. The system of any one of Embodiments 23 to 36, wherein the ratio in the edge portion is between 0.9 and 0.96 times the ratio in the central area.
41. The system of any one of Embodiments 13 to 22, wherein the SAG number of the target surface is between 9 mm and 13 mm, and the microvalving is such that a ratio of a volume of formulation applied per unit of area of the target surface near an edge thereof characterized by lying between 90% and 100% of a distance from a centroid of the target surface and a perimeter thereof, is between 0.62 and 0.85 times a maximum ratio of a volume of formulation applied per unit of area of the target surface.
42. The system of any one of Embodiments 13 to 22, wherein the SAG number of the target surface is between 7 mm and 9 mm, and the microvalving is such that a ratio of a volume of formulation applied per unit of area of the target surface near an edge thereof characterized by lying between 90% and 100% of a distance from a centroid of the target surface and a perimeter thereof, is between 0.72 and 0.92 times a maximum ratio of a volume of formulation applied per unit of area of the target surface.
43. The system of any one of Embodiments 13 to 22, wherein the SAG number of the target surface is between 5 mm and 7 mm, and the microvalving is such that a ratio of a volume of formulation applied per unit of area of the target surface near an edge thereof characterized by lying between 90% and 100% of a distance from a centroid of the target surface and a perimeter thereof, is between 0.82 and 0.96 times a maximum ratio of a volume of formulation applied per unit of area of the target surface.
44. The system of any one of Embodiments 13 to 22, wherein the microvalving is such that a ratio of a mean volume of formulation applied per unit of area of the target surface at a given point on the target surface, is equal to a reduction factor times a maximum ratio of a volume of formulation applied per unit of area at any point on the target surface, said reduction factor being equal to a cosine of an acute angle formed between (i) a plane that is tangent to the target surface at said given point and (ii) a horizontal plane.
45. The system of Embodiment 44, wherein the reduction factor at any point on a perimeter of the curved surface is between 0.63 and 0.96.
46. The system of any one of Embodiments 13 to 45, wherein for any point on the target surface, a maximum acute angle formed between (i) a plane that is tangent to the target surface at said given point and (ii) a horizontal plane is between 10° and 40°.
47. The system of any one of Embodiments 13 to 45, wherein for any point on the target surface, a maximum acute angle formed between (i) a plane that is tangent to the target surface at said given point and (ii) a horizontal plane is between 5° and 50°.
48. The system of any one of Embodiments 13 to 45, wherein for any point on the target surface, a maximum acute angle formed between (i) a plane that is tangent to the target surface at said given point and (ii) a horizontal plane is between 15° and 40°.
49. The system of any one of Embodiments 13 to 45, wherein for any point on the target surface, a maximum acute angle formed between (i) a plane that is tangent to the target surface at said given point and (ii) a horizontal plane is between 5° and 20°.
50. The system of any one of the preceding Embodiments, wherein the system is configured to perform the microvalving without any relative vertical z-axis movement between the microvalve apparatus and the target surface.
51. The system of any one of the preceding Embodiments, wherein the system is not configured to perform the microvalving while causing relative vertical z-axis movement between the microvalve apparatus and the target surface.
52. The system of any one of the preceding Embodiments, wherein the system is not configured to perform the microvalving while causing relative vertical z-axis movement between the microvalve apparatus and the target surface.
53. The system of any one of the preceding Embodiments, wherein the system is configured to perform the microvalving without any relative rotational movement on a horizontal x-y plane between the microvalve apparatus and the target surface during the forming of the wet layer.
54. The system of any one of the preceding Embodiments, wherein the system is not configured to perform the microvalving while causing relative rotational movement on a horizontal x-y plane between the microvalve apparatus and the target surface during the forming of the wet layer.
55. The system of Embodiment 54, wherein the ink-formulation-application station comprises a non-rotating optical-substrate holder.
56. The system of any of preceding Embodiment, wherein the microvalve apparatus is piezo-actuated.
57. The system of any of Embodiments 1 to 55, wherein the microvalve apparatus is electromagnetically actuated.
58. The system of any of preceding Embodiment, wherein for any point on the target surface, an acute angle formed between (i) a plane that is tangent to the target surface at said given point and (ii) a horizontal plane, is an angle (α), wherein the maximum α on the target surface is αₘₐₓ, and wherein αₘₐₓ is at least 5°.
59. The system of Embodiment 58, wherein αₘₐₓ is at least 10°.
60. The system of Embodiment 58, wherein αₘₐₓ is at least 15°.
61. The system of Embodiment 58, wherein αₘₐₓ is at least 20°.
62. The system of Embodiment 58, wherein αₘₐₓ is at least 25°.
63. The system of Embodiment 58, wherein αₘₐₓ is at least 30°.
64. The system of any one of claims 2-4, wherein αₘₐₓ is at most 50°.
65. The system of any one of Embodiments 58 to 64, wherein αₘₐₓ is within a range of 30-40°, and wherein R_{D1} is at most 0.90, or within a range of 0.62 to 0.90.
66. The system of any one of Embodiments 58 to 64, wherein max is within a range of 19-27°, and wherein R_{D1} is at most 0.93, or within a range of 0.85 to 0.93.
67. The system of any one of Embodiments 58 to 64, wherein αₘₐₓ is within a range of 15-20°, and wherein R_{D1} is at most 0.97 or within a range of 0.90 to 0.97.
68. The system of any preceding Embodiment, the system comprising any feature or features of the features provided in the formulations.
69. The system of any preceding Embodiment, the system comprising any feature or features of the features provided in the method Embodiments hereinabove.
70. The system of any preceding Embodiment, the system comprising any feature or features as described herein.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, including U.S. Pat. Nos. 4,547,397, 5,385,955, 6,538,092, 10,310,151, 4,478,876 and 5,409,965 are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method of producing an optical construction on an optical substrate, the method comprising:
(a) microvalving drops of a hardcoat formulation onto a curved, polymeric optical surface of the optical substrate, to form a wet hardcoat layer;
(b) curing the wet hardcoat layer to produce a dried transparent layer on said optical surface;
wherein the SAG number of said curved surface is at least 2 mm and at most 12 mm;
wherein said hardcoat formulation has a 25° C. viscosity of at most 15 cP;
and wherein at least one of an average diameter and a characteristic diameter of the microvalved drops (Ddrop) is within a range of 0.2 to 0.55 mm.

2. The method of claim 1, wherein Ddrop is at most 0.45 mm.

3. The method of claim 1, wherein Ddrop is at most 0.4 mm.

4. The method of claim 1, wherein Ddrop is at most 0.38 mm.

5. The method of claim 1, wherein Ddrop is at most 0.36 mm.

6. The method of any one of claims 1 to 5, wherein Ddrop is at least 0.22 mm.

7. The method of claim 6, wherein Ddrop is at least 0.24 mm.

8. The method of any one of claims 2 to 7, wherein said SAG number is at least 5 mm.

9. The method of any one of claims 2 to 8, wherein said 25° C. viscosity is within a range of 4 to 12 cP.

10. The method of any one of claims 2 to 9, wherein a total solvent content of said liquid film-forming formulation, in weight-%, is St, wherein said liquid film-forming hardcoat formulation contains a high vapor-pressure solvent Hvp and a low vapor-pressure solvent Lvp, wherein, on an n-butyl acetate normalized 25° C. evaporation rate scale, Lvp has a normalized evaporation rate (EVn) of at least 0.001 and at most 0.1, and the EVn of Hvp is at least 0.7 and at most 6.5.

11. The method of claim 10, wherein the concentration of Lvp is at least 20% of St, and the concentration of Hvp is at most 60% of St.

12. The method of claim 10, wherein the EVn of Hvp is at least 1.5.

13. The method of any one of claims 2 to 12, wherein said hardcoat formulation is a tinted hardcoat formulation.

14. The method of any one of claims 2 to 13, wherein said hardcoat formulation is applied directly to the surface of the optical substrate.

15. The method of any one of claims 2 to 13, wherein a primer is applied onto the surface of the optical substrate and cured prior to effecting step (a).

16. The method of claim 15, wherein said primer is fully cured prior to step (a).

17. The method of claim 15 or claim 16, wherein the cured or fully-cured primer has a non-tacky upper surface.

18. The method of any one of claims 2 to 17, wherein said wet hardcoat layer is formed as a continuous layer onto the surface of the optical substrate.
